(19) United States
(12) Patent Application Publication
(10) Pub. No.: US 2007/0271455 A1
(43) Pub. Date: Nov. 22, 2007

(54) Reproduction Control Device, Gate Device, and Reproduction Control System

(76) Inventors: Toshihisa Nakano, Osaka (JP); Motoji Ohmori, Osaka (JP); Atsushi Saso, Kanagawa (JP)

Correspondence Address: WENDEROTH, LIND & PONACK L.L.P., 2033 K. STREET, NW, SUITE 800, WASHINGTON, DC, 20006, US

(21) Appl. No.: 11/632,636

(22) PCT Filed: Jul. 20, 2005
(86) PCT No.: PCT/JP05/13276

§ 371 Date: Jul. 5, 2007

(30) Foreign Application Priority Data
Jul. 20, 2004 (JP) 2004-212261

(51) Int. Cl. H04L 9/00

(52) U.S. Cl. 713/154

(57) ABSTRACT

With an object of disclosing various techniques for both usage and protection of content, the present invention has an object of providing a playback control apparatus, a position judgment apparatus, and a playback control system that permit playback of content only in one area. In other to achieve the object, with the present invention, when a user passes through an automated ticket barrier to enter a station, the automated ticket barrier transmits, to a memory card via the mobile telephone, a playback key for playing content. When the user passes through an automated ticket barrier to leave a station, the automated ticket barrier instructs the memory card, via the mobile telephone, to delete the playback key, and the memory card deletes the playback key.

### TECHNICAL FIELD

The present invention relates to a technique for permitting playback of content in a limited place or space.

### BACKGROUND ART

IC cards that have a function of storing electronic money having a value equivalent to currency and performing payment using the electronic money are already in practical use. Such IC cards have uses including payment in shops and account settlement of train fares and the like.

Patent Document 1 discloses a technique with an object of providing various services that use electronic usage rights and electronic money such as that described above for telephone usage charges, tickets for trains or other transportation, and content usage. The technique relates to a system in which electronic money and electronic usage rights that have a usage time limit co-exist with electronic money and electronic usage rights that do not have a usage time limit.

Furthermore, verification experiments are being carried out for services that provide an electronic money function to mobile telephones.

Patent Document 1: Japanese Patent Application Publication No. 2001-175748

### DISCLOSURE OF THE INVENTION

### Problem to be Solved by the Invention

In view of developments in the above-described techniques, there is a demand for various techniques to be provided that both promote usage of contents by users, and improve protection of rights of the creator of contents.

In response to such demands, the present invention has an object of providing a playback control apparatus, a gate apparatus, a playback control system, a playback control method, playback control program and an LSI that permit and prohibit playback of content inside and outside an area having a gate.

### Means to Solve the Problem

In order to achieve the above object, the present invention is a playback control apparatus for permitting and prohibiting playback of content inside and outside an area having a gate, the playback control apparatus including: an acquisition unit operable to acquire, from a gate apparatus located at the gate, either one of entry information showing entry into the area through the gate and exit information showing exit from the area through the gate; and a playback control unit operable to permit playback of at least part of the content according to the entry information when the entry information is acquired, and to prohibit playback of the content according to the exit information when the exit information is acquired.

Here, permitting playback of the content includes output of information showing permission of playback of the content, to a playback mechanism that plays the content. Furthermore, prohibiting playback of the content includes refusing or stopping output of information showing that playback of the content is permitted, and deleting information showing that playback of the content is permitted.

### EFFECTS OF THE INVENTION

According to the stated structure, the playback control unit permits playback of the content when the entry information is acquired from the gate apparatus, and prohibits playback of the content when exit information is received from the gate apparatus. Therefore, users can be encouraged to use content inside the area, and dishonest usage of the content outside the area can be prevented.

Furthermore, the acquisition unit in the playback control apparatus may acquire, as the entry information, key information for decrypting encrypted content generated by encrypting the content, and the playback control unit may store the acquired key information, and permit playback of at least part of the content by outputting the stored key information.

According to the stated structure, the playback control unit permits playback of the content by outputting the key information, and therefore only when it acquires the key information from the control unit is a playback mechanism for playing the content able to decrypt the encrypted content using the key information to generate the content and play the content. Consequently, use of the content within the area can be encouraged. In addition, since the content is in an encrypted state until the key information is output, the content can be protected from dishonest playback.

The acquisition unit in the playback control apparatus of the present invention may acquire, as the exit information, a deletion instruction instructing deletion of the key information, and the playback control unit may prohibit playback of the content by deleting the stored key information in accordance with the acquired deletion instruction.

According to the stated structure, the playback control unit prohibits playback of the content by deleting the key information. Therefore, a playback mechanism that attempts to play the content outside the area is unable to decrypt the encrypted content, and dishonest use of the content outside the area can be avoided.

In the present invention, the content may be composed of a first content portion and a second content portion, the playback control unit, when the key information is acquired, may permit playback of, among the content, the first content portion, the playback control apparatus may further include: an information acquisition unit operable to acquire service information relating to a service provided inside the area, and the playback control unit may further permit playback of the second content portion when the service information is acquired.

The playback control unit, when the key information is acquired, may permit playback of at least part of the content only within a predetermined time limit, the playback control apparatus may further include: an information acquisition unit operable to acquire service information relating to a service provided inside the area, and the playback control unit may further, when the service information is acquired, release the time limit relating to playback of the content.

According to the stated structure, the playback control unit permits playback of the first content portion and the second content portion when the key information is acquired and when the service information is acquired. Therefore, the playback control unit of the present invention is able to encourage use of the content in stages according to the state of usage of services within the area by the user. Furthermore, by associating permission to play content with acquisition of service information, usage of services within the area can be encouraged.

The playback control apparatus may further include: an electronic money storage unit operable to store electronic money that is used as currency; and an account settlement unit operable to read the electronic money, and using the read electronic money, perform account settlement for a charge relating to viewing or listening to the content.

According to the stated structure, the account settlement unit uses the electronic money to perform account settlement for the charge relating to viewing or listening to the content. Therefore, the user can pay charges for using the content with the electronic money, without using currency.

The account settlement unit of the playback control apparatus may measure a playback time of the content, and perform account settlement of the charge in accordance with the playback time.

According to the stated structure, the account settlement unit performs account settlement for the charge in accordance with the playback time of the content. Accordingly, the user pays a charge that is proportionate to the playback time, and therefore even users who remain inside the area for a short time can be encouraged to view or listen to the content.

The account settlement unit of the playback control apparatus may calculate a data amount of the played content, and perform account settlement of the charge in accordance with the data amount.

According to the stated structure, the account settlement unit performs account settlement for an amount proportionate to the amount of played data of the content. This means that in the case of content such as books, newspapers and still images for which the viewing or listening time varies from user to user, the user need only pay for the portion of the content viewed or listened to. This encourages more users to view or listen to the content.

Furthermore, the content may be composed of a digital work and a digital advertisement, and the account settlement unit in the playback control apparatus of the present invention may calculate a discount amount in accordance with playback of the digital advertisement, and subtract the discount amount from an amount relating to viewing or listening to the digital work, to calculate the charge.

According to the stated structure, users can be encouraged to view or listen to the digital advertisement by discounting the charge for viewing or listening to the digital content in accordance with the playback of the digital advertisement.

The playback control apparatus may further include: a start information acquisition unit operable to acquire start information showing a playback start position in the content, wherein the playback control unit permits playback of the content by outputting the start information in addition to the key information. Furthermore, the playback control apparatus may further include: a start information storage unit operable to store the start information; and a write unit operable to acquire stop information showing a position in the content at which playback has been stopped, and write the acquired stop information, as the start information, to the start information storage unit, wherein the acquisition unit acquires the start information from the start information storage unit.

According to the stated structure, the writing means acquires, as the start information, stop information showing a position in the content at which playback was interrupted. Since the playback control unit outputs the start information together with the key information, a playback mechanism that plays the content starts playback of the content from the position in the content at which playback was interrupted. This improves usability for the user because the user can recommence viewing or listening from the position at which he/she stopped viewing or listening to the content.

The playback control apparatus may further include: an electronic money storage unit operable to store electronic money that is used as currency; and an account settlement unit operable to read the electronic money, and using the read electronic money, perform account settlement for a charge relating to using a service provided within the area. Furthermore, the account settlement unit may perform account settlement for, as the charge, a fare for a transport or an amount for a ticket for an event held in the area.

With the stated structure, since the account settlement unit performs account settlement relating to a service and the like provided within the area, the user can easily pay charges for the service without using currency.

Furthermore, the playback control apparatus may be a portable IC memory card.

This means that the playback control apparatus of the present invention is convenient and easily portable by the user, and that the playback control apparatus of the present invention can be used in various devices that use a portable IC memory card, such as mobile telephone and PDAs.

The playback control apparatus may be a mobile terminal, and the mobile terminal may further include: a playback unit operable to play the content when the playback control unit permits playback of the content.

Currently, large numbers of people regularly carry mobile terminals such as mobile telephones. Therefore, by taking the form of a mobile terminal, the playback control apparatus of the present invention can be easily popularized and has increased industrial applicability. Furthermore, since mobile telephones include playback means for playing content, as long as the user possesses a mobile telephone, he/she can view or listen to the content without the need for any other playback device.

Furthermore, the mobile terminal may obtain the content via the Internet.

According to the stated structure, since the mobile terminal acquires the content via the Internet, the user can acquire the content easily without the need to go to a shop or the like to purchase the content or a recording medium that stores the content.

The playback control apparatus may be a playback apparatus and may further include: a playback unit operable to play the content when the playback control unit permits playback of the content.

According to the stated structure, the playback apparatus acquires either of the entry information and the exit information, and in the case of the entry information being acquired, permits playback of the content, and when playback of the content is permitted, plays the content. Accordingly, the user is able to view or listen to the content inside the area without the need of another playback device.

The playback control apparatus may further include: a notification unit operable to, when the playback control unit prohibits playback, give notification that playback of the content is possible within the area.

According to the stated structure, when playback is prohibited, in other words when the user is outside the area, the playback control apparatus of the present invention notifies the user that playback of the content is possible within the area. Therefore, the user can be encouraged to use the content within the area.

The playback control apparatus may further include: a notification unit operable to, when the playback control unit prohibits playback, give notification that playback of the content is possible within the area.

According to the stated structure, the playback control apparatus stores the key information in advance. This eliminates the need to transfer the key information between the gate apparatus and the playback control apparatus, and reduces the risk of the key information being leaked.

The acquisition unit in the playback control apparatus may acquire the content as the entry information, and the playback control unit may store the acquired content, and permit playback of the content by outputting the stored content. Furthermore, the acquisition unit may acquire, as the exit information, a deletion instruction instructing deletion of the content, and the playback control unit may prohibit playback of the content by deleting the stored content in accordance with the acquired deletion instruction.

According to the stated structure, the acquisition unit acquires the content as the entry information, and the playback control unit permits playback of the content by outputting the content. Therefore, a playback device can play the content promptly without having to perform decryption processing and the like of the content. Furthermore, by prohibiting playback of the content by deleting the content, the playback apparatus is unable to play the content. This ensures that dishonest playback of the content after the user leaves the area is avoided.

The present invention is a gate apparatus that is located at a gate of an area, and communicates with a playback control apparatus in accordance with entry and exit to and from the area by the playback control apparatus, the playback control apparatus permitting and prohibiting playback of content inside and outside the area, the gate apparatus comprising: a detection unit operable to detect the playback control apparatus; a transmission unit operable to, upon the detection unit detecting the playback control apparatus, transmit to the playback control apparatus entry information showing entry into the area through the gate, or exit information showing exit from the area through the gate.

According to the stated structure, upon detecting entry or exit of the playback apparatus, the gate apparatus outputs entry information or exit information to the playback control apparatus. By acquiring the entry information or the exit information, the playback control apparatus can distinguish whether it is inside the area or outside the area, and control playback of content accordingly.

Furthermore, the playback control apparatus, when the exit information is received, may prohibit playback of the content, and transmit prohibition completion information showing that playback of the content is prohibited, and the gate apparatus may further include: a reception unit operable to receive the prohibition completion information from the playback control apparatus; a judgment unit operable to judge whether or not the prohibition completion information was received normally; and a gate control unit operable to close the gate when the judgment unit judges that the prohibition completion information was not received normally.

According to the stated structure, when it is judged that the prohibition completion information has not been received normally, the gate control unit closes the gate. This ensures that dishonest playback of the content outside the gate is prevented.

The present invention is a playback control system including a gate apparatus located at a gate to an area, and a playback control apparatus that permits and prohibits playback of the content inside and outside the area, the gate apparatus including: a detection unit operable to detect the playback control apparatus; and a transmission unit operable to, upon the detection unit detecting the playback control apparatus, transmit to the playback control apparatus entry information showing entry into the area through the gate, or exit information showing exit from the area through the gate, and the playback control apparatus includes: an acquisition unit operable to acquire the entry information from the gate apparatus when the entry information is transmitted, and acquire the exit information from the gate apparatus when the exit information is transmitted; and a playback control unit operable to permit playback of at least part of the content according to the entry information when the entry information is acquired, and to prohibit playback of the content according to the exit information when the exit information is acquired.

According to the stated structure, the playback control apparatus permits playback of the content when the entry information is acquired. This promotes usage of the content inside the area. On the other hand, since the playback control apparatus prohibits playback of the content when the exit information is acquired, dishonest use of the content outside the area is prevented.

### BRIEF DESCRIPTION OF THE DRAWINGS

FIG. 1 is a structural drawing showing the structure of a location-limited content usage system 1;

FIG. 2 is a block diagram showing the structure of a content management apparatus 200;

FIG. 3 shows an example of information stored in a content information storage unit 211;

FIG. 4 shows details of a content information table 221;

FIG. 5 is a block diagram showing the structure of a memory card 300;

FIG. 6 is a block diagram showing the structure of an electronic money charger 600;

FIG. 7 is examples of screens displayed by a display unit 613 of the electronic money charger 600;

FIG. 8 is a block diagram showing the structure of a mobile telephone 100;

FIG. 9 is a block diagram showing the structure of an automated ticket barrier 400;

FIG. 10 is an example of information stored in the information storage unit 410;

FIG. 11 shows details of a fare table 441;

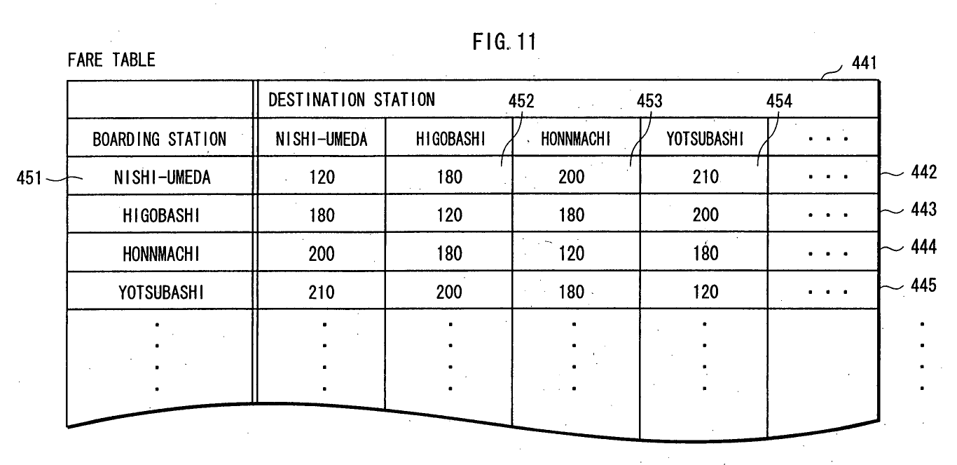

FIG. 12 is a flowchart showing operations for electronic money deposit processing by the electronic money charger 600 and a memory card 300;

FIG. 13 is a flowchart showing operations for entry processing by the automated ticket barrier 400, the mobile telephone 100 and the memory card 300;

FIG. 14 is a flowchart showing operations for content playback processing by the mobile telephone 100;

FIG. 15 is a flowchart showing operations for exit processing by the automated ticket barrier 400, the mobile telephone 100 and the memory card 300, and continues in FIG. 16;

FIG. 16 is a flowchart showing operations for exit processing by the automated ticket barrier 400, the mobile telephone 100 and the memory card 300, and continues from FIG. 15;

FIG. 17 is a flowchart showing operations for authentication processing between two devices, and continues in FIG. 18;

FIG. 18 is a flowchart showing operations for authentication processing between two devices, and continues from FIG. 17;

FIG. 19 shows the flow of information transmitted and received between devices in the location-limited content usage system 1;

FIG. 20 shows the flow of information transmitted and received between devices in the location-limited content usage system 1;

FIG. 21 is a structural drawing showing the structure of an area-limited content usage system 2;

FIG. 22 shows an example of information stored in a content information storage unit 261;

FIG. 23 shows details of a viewing/listening area table 271;

FIG. 24 is a block diagram showing the structure of a memory card 350;

FIG. 25 shows details of playback information 383 and current position information 385;

FIG. 26 is a block diagram showing the structure of a mobile telephone 150;

FIG. 27 is a flowchart showing operations of a memory card 350;

FIG. 28 is a flowchart showing operation for position judgment processing by the memory card 350;

FIG. 29 is a flowchart showing operations for content output from the memory card 350 to the mobile telephone 150;

FIG. 30 is a flowchart showing operations for content output end check processing by the memory card 350, and continues in FIG. 31;

FIG. 31 is a flowchart showing operations for content output end check processing by the memory card 350, and continues from FIG. 30; and

FIG. 32 is a block diagram showing the structure of a memory card 700 in a third embodiment.

### DESCRIPTION OF NUMERIC REFERENCES

1 Location-limited content usage system
2 Area-limited content usage system
10 Mobile telephone network
15 Base station
16 GPS satellite
20 Internet
25 Content distribution manufacturer
30 Shop
35 Train
100 Mobile telephone
150 Mobile telephone
200 Content management apparatus
250 Content management apparatus
300 Memory card
350 Memory card
420 Automated ticket barrier
600 Electronic money charger
700 Memory card

### BEST MODE FOR CARRYING OUT THE INVENTION

The following describes preferred embodiments of the present invention with use of the drawings.

### 1. First Embodiment

The following describes a location-limited content usage system as an embodiment of the present invention.

1.1 Location-Limited Content Usage System

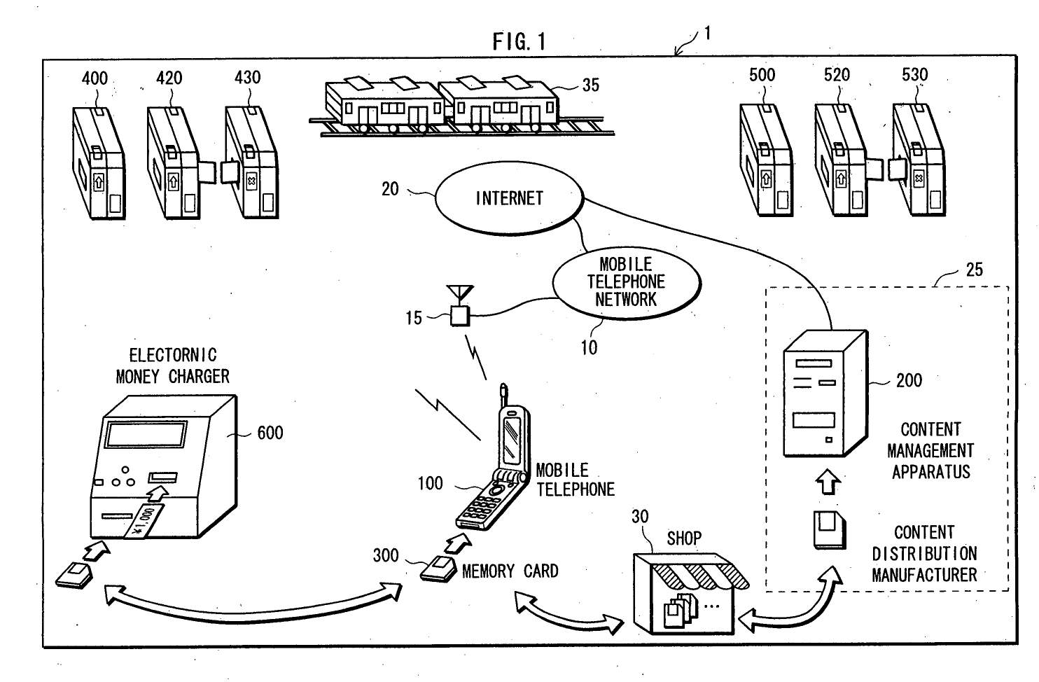

As shown in FIG. 1, a location-limited content usage system 1 is composed of a mobile telephone 100, automated ticket barriers 400, 420, 430, 500, 520, 530 . . . , and an electronic money charger 600.

A content management apparatus 200 possessed by a content distribution maker 25 is connected to the Internet 20. Furthermore, a mobile telephone 100 is connected to the Internet 20 via a mobile telephone network 10 and a base station 15.

The content management apparatus 200 stores content, examples of which are movies and television programs composed of audio and video, and books and newspapers composed of text data. The content management apparatus 200 also stores sets of a content key that is unique to a content, encrypted content that has been generated by encrypting the content using the corresponding content key, an encrypted content key that has been generated by encrypting the corresponding content key, and a charge relating to viewing/listening to the corresponding content. The content management apparatus 200 also stores a playback key used to generate the encrypted content keys.

According to an operation by an operator, the content management apparatus 200 writes an encrypted content key and encrypted content to a memory card 300.

At a shop 30, a user of the mobile telephone 100 purchases the memory card 300 that stores therein the encrypted content key and the encrypted content.

The mobile telephone 100, which the memory card 300 is mountable in, plays the content stored in the memory card 300.

The memory card 300 stores therein electronic money, and the user adds to the electronic money in the memory card 300 by using the electronic money charger 600.

The automated ticket barriers 400, 420, 430, 500, 520 . . . each store therein a playback key.

When the user enters the station with the memory card 300 mounted in the mobile telephone 100, the memory card 300 receives the playback key from one of the automated ticket barriers 400, 420, 430, 500, 520 . . . using short distance wireless communication.

When playback of content is instructed by an operation by the user, the mobile telephone 100 reads the playback key, the encrypted content key, and the encrypted content from the memory card 300, and decrypts the encrypted content key using the read playback key to generate a content key. The mobile telephone 100 decrypts the encrypted content using the generated content key, to generate content, and plays the generated content.

When the user leaves a station, the memory card 300 deletes the playback key in accordance with an instruction from the automated ticket barrier 400.

In this way, the user is able to view/listen to the content only during the period from entering a station through to leaving a station.

1.2 Content Management Apparatus 200

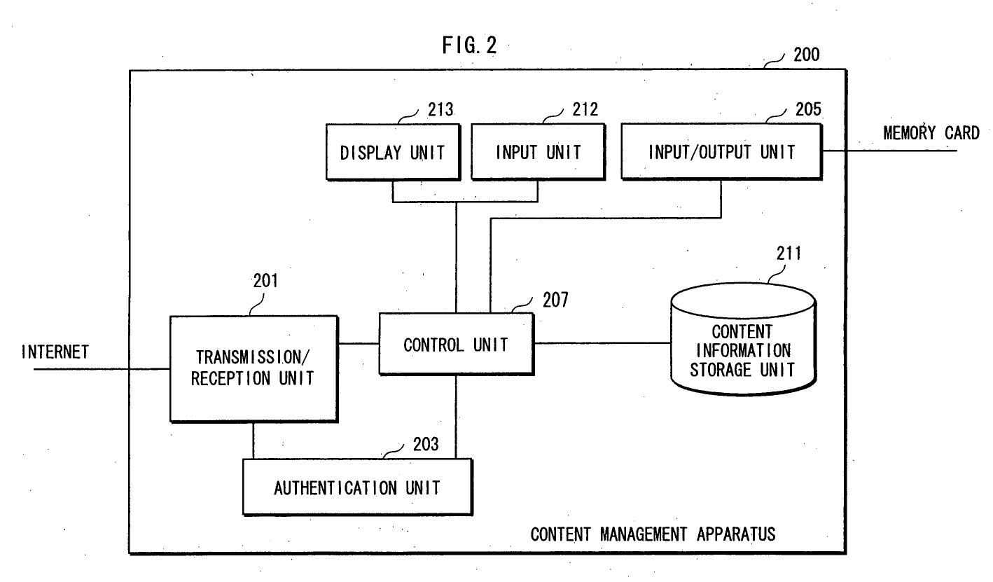

As shown in FIG. 2, the content management apparatus 200 is composed of a content information storage unit 211, a transmission/reception unit 201, an input/output unit 205, a control unit 207, an authentication unit 203, an input unit 212, and a display unit 213.

Specifically, the content management apparatus 200 is composed of a microprocessor, a RAM, a ROM, and a hard disk. Computer programs are stored in the RAM, the ROM and the hard disk, and the content management apparatus 200 achieves its functions by the microprocessor operating according to the computer programs.

(1) Content Information Storage Unit 211

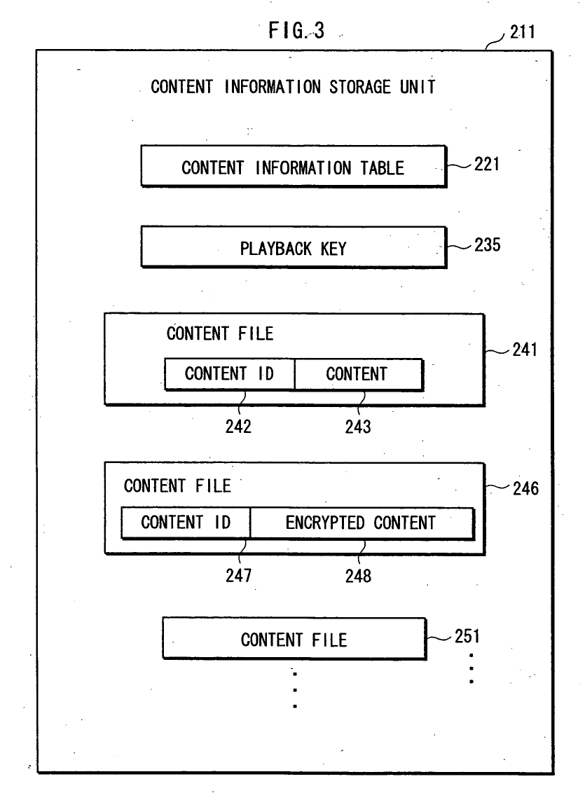

As one example, the content information storage unit 211 is composed of a hard disk, and, as shown in FIG. 3, stores a content information table 221, a playback key 235, and content files 241, 246, 251 . . .

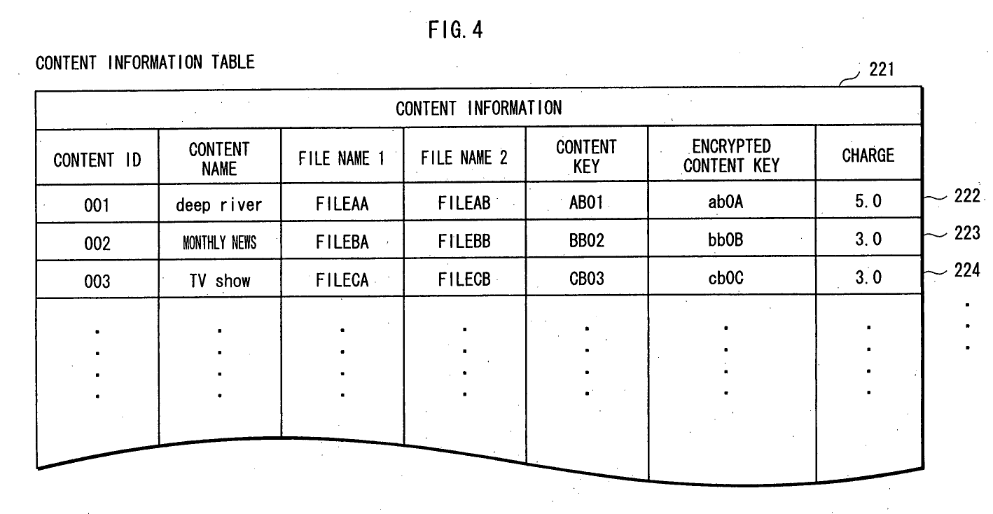

As shown in FIG. 4, the content information table 221 is composed of a plurality of content information 222, 223, 224 . . . , each of which includes a content ID, a content name, a file name 1, a file name 2, a content key, an encrypted content key, and a charge. The content ID is an identification information that uniquely identifies the content. The content name is the name of content such as the name of a movie or the name of a television program. The file name 1 is the name of a content file that includes the content shown by the content ID. The file name 2 is the name of a content file that includes encrypted content that has been generated by subjecting the content shown by the content ID to an encryption algorithm E1 using the content key. The content key is an encryption key used to generate the described encrypted content, and differs for each content. The encrypted content key has been generated by subjecting the content key to an encryption algorithm E2 using the playback key 235.

Here, the encryption algorithms E1 and E2 are, as one example, DES (Data Encryption Standard).

The charge is a viewing/listening charge per minute of the content identified by the content ID, and is expressed in units of “yen per minute”.

Among the content files 241, 246, 251 . . . , one or more includes a content ID and content, while another one or more includes a content ID and encrypted content.

The content file 241 includes a content ID 242 and content 243, and the content ID 242 is identical to a content ID “001” included in the content information 222.

The content file 246 includes a content ID 247 and encrypted content 248. The content ID 247 is identical to the content ID “001” included in the content information 222. The encrypted content 248 has been generated by subjecting the content 243 to the encryption algorithm E1 using a content key “AB01”.

(2) Transmission/Reception Unit 201 and Input/Output Unit 205

The transmission/reception unit 201 performs transmission/reception of information between the control unit 207 and an external device connected to the Internet 20, and between the authentication unit 203 and the external device.

Here, the external device is either of the mobile telephone 100 and the memory card 300 mounted in the mobile telephone 100.

The input/output unit 205 is connected to the memory card 300, and performs transmission/reception of information between the memory card 300, the control unit 207 and the authentication unit 203.

(3) Authentication Unit 203

The authentication unit 203 stores a secret key unique to the content management apparatus 200, a public key certificate, a public key of a certificate authority that issued the public key certificate, and a CRL (Certificate_Revocation_List).

The public key certificate shows the legitimacy of the public key that is a pair with the secret key, and includes the public key and a certificate ID. The CRL includes one or more certificate IDs of one or more revoked public key certificates.

When the memory card 300 is mounted into the input/output unit 205, the authentication unit 203 performs device authentication with the memory card 300. When the device authentication succeeds, the authentication unit 203 outputs a session key generated according to the device authentication to the control unit 207.

Furthermore, before the control unit 207 performs transmission/reception of information with an external apparatus connected to the Internet 20, the authentication unit 203 performs device authentication with the external device via the transmission/reception unit 201 and the Internet 20. When device authentication succeeds, the authentication unit 203 outputs a session key generated according to the device authentication to the control unit 207.

Device authentication is described later.

(4) Control Unit 207

When device authentication between the authentication unit 203 and the memory card 300 succeeds, the control unit 207 receives the session key generated according to the device authentication from the authentication unit 203. Although information transmitted/received to/from the memory card 300 is encrypted using the received session key before being transmitted, for brevity of explanation hereinafter, processing for encryption and decryption using the session key are not mentioned.

The control unit 207 receives input of instructions and information from the user via the input unit 212, and performs various processing based on the received instructions.

Upon receiving a write instruction for the content ID “001” and content via the input unit 212, the control unit 207 selects, the content information 222 that includes the received content ID “001” from the content information table 221, extracts the content ID “001”, the encrypted content key “ab0A” and the charge “5.0” from the selected content information 222, and writes the extracted content ID “001”, encrypted content key “ab0A” and charge “5.0” as playback information to a secure area 321 in the memory card 300. Next, the control unit 207 extracts the file name 2 included in the selected content information 222, reads the encrypted content 248 from the content file 246 of the extracted file name 2, and writes the read encrypted content 248 to a general area 331 of the memory card 300.

(5) Input Unit 212 and Display Unit 213

The input unit 212 receives input of information or an instruction from a user of the content management apparatus 200, and outputs the received information or instruction to the control unit 207.

The display unit 213 displays various information under the control of the control unit 207.

1.3 Content Distribution Manufacturer 25 and Shop 30

The content distribution manufacturer 25 mass produces, using the content management apparatus 200, memory cards 300 having encrypted content and playback information stored therein, and sells the produced memory cards 300 via the shop 30.

1.4 Memory Card 300

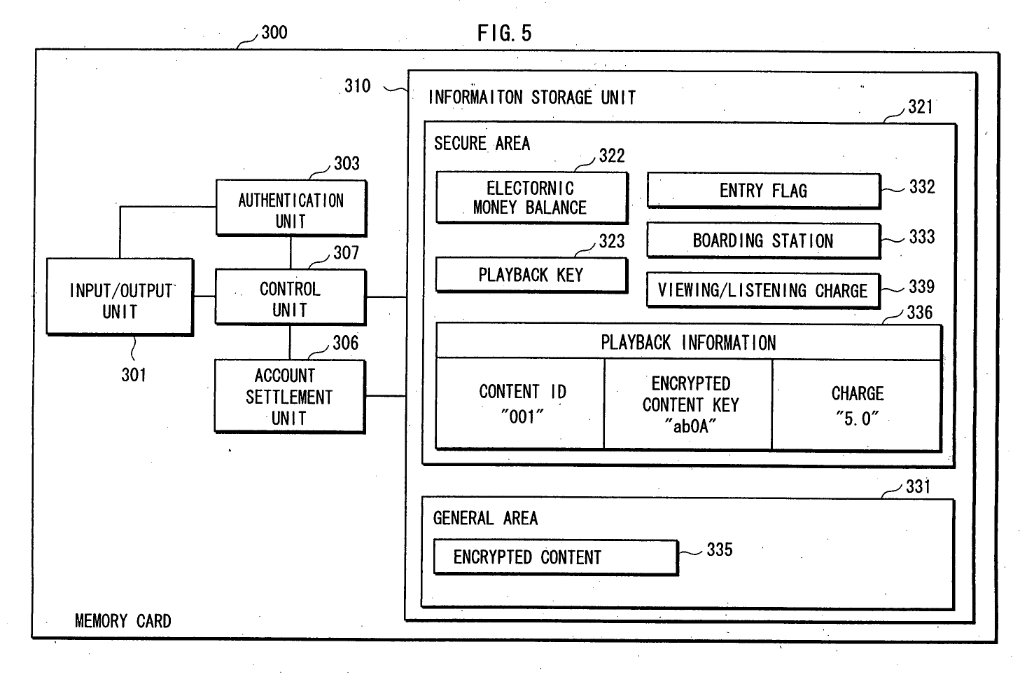

As shown in FIG. 5, the memory card 300 is composed of an information storage unit 310, an input/output unit 301, a control unit 307, a account settlement unit 306, and an authentication unit 303.

The memory card 300 is specifically a computer system composed of a microprocessor, a RAM, a ROM, and EEPROM and the like. Computer programs are stored in the RAM and the ROM, and the memory card 300 achieves part of its functions by the microprocessor operating in accordance with the programs.

Note that the authentication unit 303 performs device authentication with an external device, and generates a common session key. Although information transmitted/received to/from the external device by the control unit 307 is encrypted using the received session key before being transmitted, for brevity of explanation hereinafter, processing for encryption and decryption using the session key are not mentioned.

(1) Information Storage Unit 310

Although not specifically illustrated, the information storage unit 310 is composed of a nonvolatile writable storage device such as an EEPROM or a flash memory.

The information storage unit 310 includes a secure area 321 and a general area 331. An external device that fails in device authentication with the authentication unit 303 is unable to use information stored in the secure area 321. As shown in FIG. 5, the secure area 321 stores an electronic money balance 322, a playback key 323, an entry flag 332, a boarding station 333, a viewing/listening charge 339, and playback information 336. The general area 331 stores encrypted content 335.

The electronic money balance 322 is the amount of the electronic money stored in the memory card 300.

The playback key 323 is a key value for decrypting the encrypted content key “ab0A” included in the playback information 336, and is identical to the playback key 235 stored by the content management apparatus 200.

The entry flag 332 shows whether or not entry processing between the memory card 300 and any of the automated ticket barriers 400, 420, 430 . . . has been performed or not. The entry flag 332 is “1” when the entry processing has been performed, and “0” when the entry processing has not been performed. Note that this processing is described later.

The boarding station 333 is the name of the station at which the memory card 300 performed the entry processing (described later) at via the mobile telephone 100.

The viewing/listening charge 339 is a charge incurred as a result of the mobile telephone 100 playing the content, and the initial value thereof is set to “0”.

The playback information 336 includes a content ID “001”, an encrypted content key “ab0A”, and an amount “5.0”. The content ID “001” is identification information corresponding to content generated by decrypting the encrypted content 335. The encrypted content key “ab0A” is an encrypted content key generated by encrypting, using a playback key, a content key “AB01” for decrypting the encrypted content 335. The charge “5.0” shows a monetary charge for viewing/listening to content shown by the content ID “001”, and is expressed in units of yen per minute. The content ID “001”, the encrypted content key “ab0A” and the amount “5.0” are identical to those included in the content information 222.

The encrypted content 335 is encrypted content generated by encrypting content such as a movie or a television program, and is identical to the encrypted content 248 stored in the content management apparatus 200.

Note that the memory card 300 may already store therein the encrypted content 335 and the playback information 336 when dispatched from the content distribution manufacturer 25, or may acquire the encrypted content 335 and the playback information 336 from the content management apparatus 200 via the Internet 20 and the mobile telephone 100 after dispatch.

(2) Input/Output Unit 301

The input/output unit 301 performs transmission/reception of various information between the control unit 307 and an external device, and the authentication unit 303 and the external device. Here, the external device is any of the mobile telephone 100, the content management apparatus 200 and the electronic money charger 600.

(3) Authentication Unit 303

The authentication unit 303 stores a secret key, a public key certificate, a public key, and a CRL. The secret key is unique to the memory card 300. The public key certificate includes the public key that is a pair with the secret key. The public key is the public key of the certificate authority that issued the public key certificate. The CRL includes one or more certificate IDs of revoked public key certificates.

Upon the memory card 300 being mounted in the external apparatus, the authentication unit 303 performs device authentication with the external device, and generates a session key. Device authentication is described later.

(4) Account Settlement Unit 306

The account settlement unit 306 receives an insertion amount and an instruction to perform account settlement from the control unit 307. The account settlement unit 306 also receives a fare and an instruction to perform account settlement from the control unit 307.

Upon receiving the inserted amount and the instruction to perform account settlement from the control unit 307, the account settlement unit 306 reads the electronic money balance 322 stored in the secure area 321 of the information storage unit 310, adds the inserted amount to the read electronic money balance 322, and overwrites the electronic money balance 322 in the secure area 321 with the electronic money balance obtained as a result of the addition. The account settlement unit 306 then outputs an end signal, to the control unit 307, showing that electronic money account settlement has finished normally.

Upon receiving a fare and the instruction to perform account settlement from the control unit 307, the account settlement unit 306 reads viewing/listening charge 339 from the information storage unit 310, and calculates a total of the received fare and the read viewing/listening charge 339. The account settlement unit 306 reads the electronic money balance 322 from the secure area 321 of the information storage unit 310, and compares the read electronic money balance 322 and the calculated total. If the electronic money balance 322 it equal to or greater than the total, the account settlement unit 306 subtracts the total from the electronic money balance 322, and overwrites the electronic money balance 322 in the secure area 321 to show an electronic money balance that results from the subtraction. The account settlement unit 306 then outputs, to the control unit 307, an end signal showing that electronic money account settlement processing has ended normally.

When the read electronic money balance 322 is less than the calculated total, the account settlement unit 306 generates an error signal showing that the electronic money is insufficient, and outputs the generated error signal to the control unit 307.

(5) Control Unit 307

When device authentication between the authentication unit 603 of the electronic money charger 600 and the authentication unit 303 succeeds, the control unit 307 receives an inserted amount from the electronic money charger 600 via the input/output unit 301. The control unit 307 outputs the received inserted amount to the account settlement unit 306, and instructs the account settlement unit 306 to perform account settlement. Next, the control unit 307 receives an end signal showing that electronic money account settlement finished normally from the account settlement unit 306.

Furthermore, when the user carries the mobile telephone 100 having the memory card 300 mounted therein into a station, the control unit 307 receives a communication start signal from the automated ticket barrier 400 via the mobile telephone 100. At this time, the control unit 307 performs the following (i) entry processing with the automated ticket barrier 400.

When the user carries the mobile telephone 100 having the memory card 300 mounted therein out of a station, the control unit 307 receives a communication start signal from the automated ticket barrier 400 via the mobile telephone 100. At this time, the control unit 307 performs the following (iii) exit processing with the automated ticket barrier 400.

Furthermore, when the memory card 300 is in a mounted state in the mobile telephone 100, the control unit 307 receives a content request signal and a current time from the mobile telephone 100 via the input/output unit 301, and performs (ii) content playback processing.

The following describes (i) entry processing, (ii) content playback processing, and (iii) exit processing.

Although (i) entry processing and (iii) exit processing are only described as being performed between the automated ticket barrier 400 and the memory card 300, the automated ticket barriers 420, 430, 500 . . . perform the same processing.

(i) Entry Processing

Upon receiving a communication start signal from the automated ticket barrier 400 via the mobile telephone 100, the control unit 307 generates a response signal showing that communication is possible, and transmits the generated response signal to the automated ticket barrier 400 via the mobile telephone 100.

If device authentication by the authentication unit 303 fails, communication with the automated ticket barrier 400 is discontinued.

When device authentication by the authentication unit 303 succeeds, the control unit 307 then receives, as the boarding station, the name of the station at which the automated ticket barrier 400 is located, from the automated ticket barrier 400. The control unit 307 writes the received boarding station to the secure area 321 of the information storage unit 310, and sets the entry flag 332 to “1”. Although the control unit 307 receives the boarding station and rewrites the entry flag in the present explanation, the control unit 307 may further receive a boarding date and time, and write (or rewrite) the boarding date and time to the information storage unit 310.

Next, the control unit 307 generates a playback key request signal, and transmits the generated playback key request signal to the automated ticket barrier 400 via the input/output unit 301.

The control unit 307 receives the playback key from the automated ticket barrier 400 via the input/output unit 301, and writes the received playback key to the secure area 321.

(ii) Content Playback Processing

Here, it is assumed that device authentication between the authentication unit 103 of the mobile telephone 100 and the authentication unit 303 has succeeded.

The control unit 307 receives, from the mobile telephone 100 via the input/output unit 301, a content request signal, and a current time that is the time at which the mobile telephone 100 transmitted the content request. The control unit 307 temporarily stores the received current time as a playback start time.

Here, if the playback key 323 has not been written to the secure area 321 of the information storage unit 310, the control unit 307 outputs, to the mobile telephone 100 via the input/output unit 301, an error signal showing that the content cannot be played because entry processing has not been performed.

Next, the control unit 307 reads the playback key 323, and the encrypted content key “ab0A” and the encrypted content 335 included in the playback information 336 from the information storage unit 310, and outputs the read playback key 323, encrypted content key “ab0A” and encrypted content 335 to the mobile telephone 100 via the input/output unit 301. More specifically, the encrypted content 335 is composed of a plurality of blocks, and the control unit 307 reads the blocks successively in order from the first block, and successively outputs the read blocks to the mobile telephone 100.

The control unit 307 receives, from the mobile telephone 100 via the input/output unit 301, a playback end signal, and a current time that is the time at which the mobile telephone 100 transmitted the playback end signal. Upon receiving the playback end signal and current time, the control unit 307 stops output of the encrypted content 335.

Next, based on the stored playback start time and a playback end time which is the received present time, the control unit 307 calculates a playback time as follows:
Expression: playback time=playback end time−playback start time

Next, the control unit 307 reads the amount “5.0” included in the playback information 336 stored in the information storage unit 310, and calculates the product of the read amount “5.0” and the calculated time. The control unit 307 then reads the viewing/listening charge 339, calculates the total of the calculated product and the read viewing/listening charge 339, and overwrites the viewing/listening charge 339 with the calculated total.

(iii) Exit Processing

Upon receiving a communication start signal from the automated ticket barrier 400 via the mobile telephone 100, the control unit 307 generates a response signal showing that communication is possible, and transmits the generated response signal to the automated ticket barrier 400 via the mobile telephone 100.

Note that if the encrypted content 335 is being output to the mobile telephone 100 when the communication start signal is received, the control unit 307 forcedly stops the output of the encrypted content 335, and makes a request to the mobile telephone 100 for the current time. The control unit 307 then acquires the current time from the mobile telephone 100, and, using the acquired current time as an end time, performs calculation and overwriting as described in (ii) content playback processing. The control unit 307 then performs the following processing.

The control unit 307 instructs the authentication unit 303 to perform device authentication with the automated ticket barrier 400. If the device authentication by the authentication unit 303 fails, the control unit 307 stops subsequent communication with the automated ticket barrier 400.

When device authentication by the authentication unit 303 succeeds, the control unit 307 receives a account settlement start signal from the automated ticket barrier 400 via the mobile telephone 100 and the input/output unit 301. Upon receiving the account settlement start signal, the control unit 307 reads the entry flag 332 and the boarding station 333 from the secure area 321 and the information storage unit 310, and transmits the read entry flag 332 and the boarding station 333 to the automated ticket barrier 400 via the input/output unit 301 and the mobile telephone 100. Here, when the boarding station 333 does not exist in the information storage unit 310, the control unit 307 transmits “000” as the boarding station 333.

Next, the control unit 307 receives a fare from the automated ticket barrier 400 via the mobile telephone 100 and the input/output unit 301, outputs the received fare to the account settlement unit 306, and instructs the account settlement unit 306 to perform account settlement.

Upon receiving an end signal showing that account settlement of the electronic money ended normally from the account settlement unit 306, the control unit 307 generates a account settlement result “1”. Upon receiving an error signal showing that the electronic money is insufficient, from the account settlement unit 306, the control unit 307 generates a account settlement result “0”.

Next, the control unit 307 transmits the generated account settlement result to the automated ticket barrier 400 via the input/output unit 301 and the mobile telephone 100.

If the generated account settlement result is “0”, the control unit 307 stops subsequent processing.

If the generated account settlement result is “1”, the control unit 307 then receives a key deletion instruction from the automated ticket barrier 400 via the mobile telephone 100 and the input/output unit 301. Upon receiving the key deletion instruction, the control unit 307 deletes the stored playback key 323 from the secure area 321 of the information storage unit 310, and initializes the viewing/listening charge 339 to “0”.

Next, the control unit 307 receives a account settlement completion signal from the automated ticket barrier 400 via the input/output unit 301 and the mobile telephone 100. Upon receiving the account settlement completion signal, the control unit 307 deletes the boarding station 333, and sets the entry flag 332 to “0”.

Although the control unit 307 is described as deleting the boarding station and the changing the entry flag upon receiving the account settlement completion signal, the control unit 307 may instead receive a boarding station deletion instruction and an entry flag “0”, and delete the boarding station and overwrite the entry flag.

1.5 Electronic Money Charger 600

The electronic money charger 600 is located at a convenience store, a station, or the like, and is for storing a user's cash to the memory card 300 as electronic money.

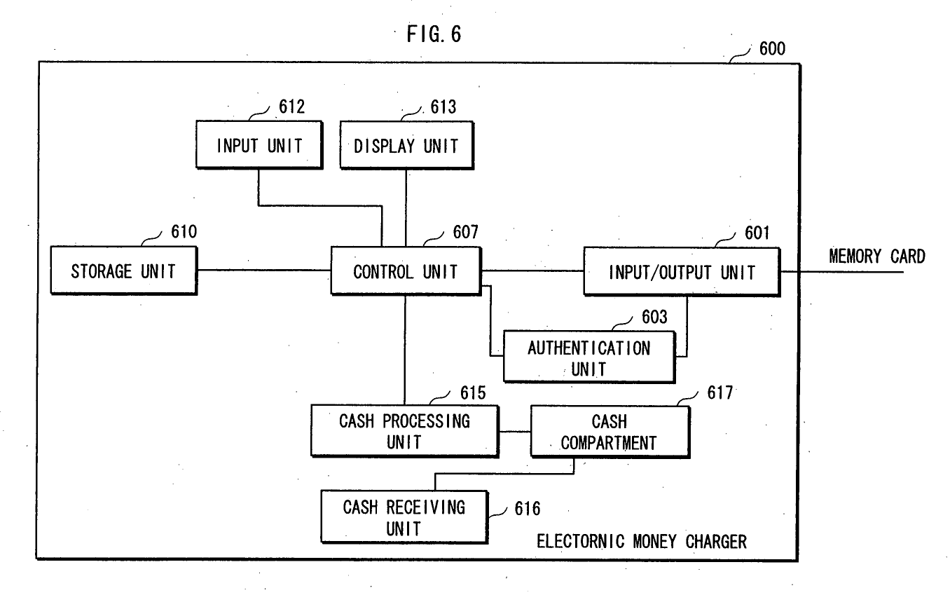

As shown in FIG. 6, the electronic money charger 600 is composed of a storage unit 610, an input/output unit 601, a cash receiving unit 616, a cash processing unit 615, a cash compartment 617, a control unit 607, an authentication unit 603, an input unit 612, and a display unit 613.

Specifically, the electronic money charger 600 is composed of a microprocessor, a RAM, a ROM, and the like. Computer programs are stored in the RAM, the ROM and the storage unit 610, and the electronic money charger 600 achieves its functions by the microprocessor operating according to the computer program.

(1) Storage Unit 610

The storage unit 610 is composed of a RAM, a ROM, a hard disk and the like, and stores computer programs, various image data, and so on.

(2) Input/Output Unit 601

The input/output unit 601 is connected to the memory card 300, and performs transmission/reception of information between the memory card 300 and the control unit 607, and between the memory card 300 and the authentication unit 603.

(3) Input Unit 612 and Display Unit 613

The input unit 612 includes buttons such as a start button, an OK button, and an add button. Upon detecting a press of any one of the buttons by a user, the input unit 612 outputs, to the control unit 607, operation instruction information corresponding to the button detected as being pressed.

The display unit 613 displays various information under the control of the control unit 607. A standby screen 621, an money insertion screen 622, a confirmation screen 623, and an end screen 624 are examples of screens displayed by the display unit 613.

(4) Cash Receiving Unit 616, Cash Processing Unit 615, and Cash Compartment 617

The cash compartment 617 is for safe-keeping cash.

The cash receiving unit 616 receives cash inserted therein by a user, and stores the received cash in the cash compartment 617.

The cash processing unit 615 counts the cash inserted by the user, and outputs a total amount of the counted cash to the control unit 607 as an inserted amount.

(5) Authentication Unit 603

The authentication unit 603 stores a secret key unique, a public key certificate, and a CRL. The secret key is unique to the electronic money charger 600. The public key certificate includes the public key that is a pair with the secret key. The CRL includes the public key of the certificate authority that issued the public key certificate, and one or more certificate IDs of revoked public key certificates.

Upon the memory card 300 being mounted in the input/output unit 601, the authentication unit 603 performs device authentication with the external device, and generates a session key.

(6) Control Unit 607

When device authentication between the authentication unit 603 and the authentication unit 303 of the memory card 300 fails, the control unit 607 does not perform transmission/reception of information with the memory card 300.

When device authentication succeeds, the control unit 607 receives operation instruction information showing that any one of the buttons has been pressed from the input unit 612, and in accordance with the received operation instruction information, performs electronic money deposit processing described below. In the electronic money deposit processing described below, the control unit 607 performs secret key communication using a session key generated according to the device authentication between the authentication unit 603 and the memory card 300. However, for brevity of explanation, processing for encryption and decryption using the session key are not described here.

(Electronic Money Deposit Processing)

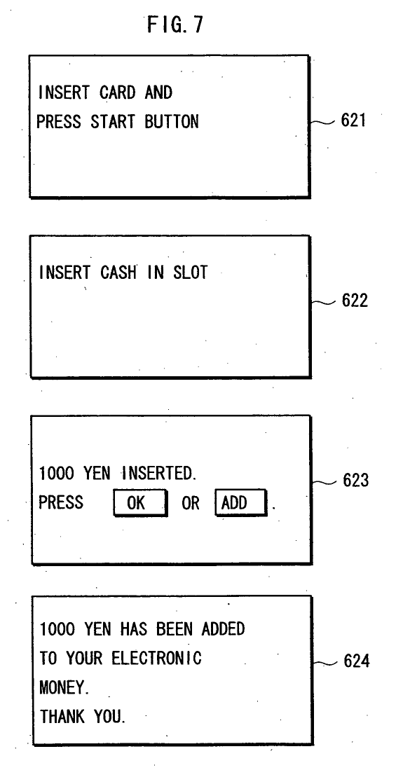

When device authentication by the authentication unit 603 succeeds, and operation instruction information showing a press of the start button is received from the input unit 612, the control unit 607 generates an money insertion screen, outputs the generated money insertion screen to the display unit 613, and instructs the display unit 613 to display the money insertion screen. The money insertion screen 622 shown in FIG. 7 is a screen displayed here.

When an insertion amount is received from the cash processing unit 615, the control unit 607 generates a confirmation screen using the received insertion amount, and displays the generated confirmation screen. The confirmation screen 623 shown in FIG. 7 is an example of the screen displayed here.

Next, the control unit 607 receives operation instruction information showing pressing of the add button, or operation instruction information showing pressing of the OK button.

When the operation instruction information showing pressing of the add button is received, the control unit 607 continues to receive insertion amounts from the cash processing unit 615, to generate a confirmation screen, and display the confirmation screen, until receiving operation instruction information showing pressing of the OK button.

When operation instruction information showing pressing of the OK button is received, the control unit 607 transmits the insertion amount received from the cash processing unit 615 to the memory card 300 via the input/output unit 601.

Next, the control unit 607 generates an end screen, outputs the generated end screen to the display unit 613, and instructs the display unit 613 to display the end screen. The end screen 624 shown in FIG. 7 is an example of the screen displayed here.

When a set period of time elapses from when the display of the end screen 624 commences, the control unit 607 generates a standby screen, outputs the standby screen to the display unit 613, and instructs the display unit 613 to display the standby screen. The standby screen 621 shown in FIG. 7 is an example of the screen displayed here.

1.6 Mobile Telephone 100

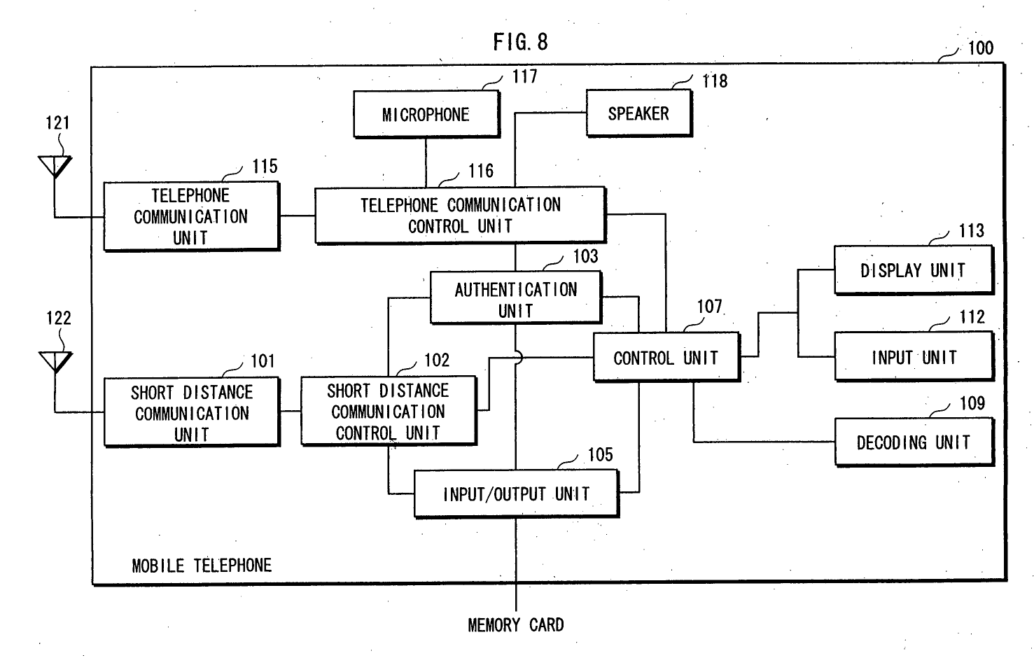

As shown in FIG. 8, the mobile telephone 100 is composed of a telephone communication unit 115, a telephone communication control unit 116, a microphone 117, a speaker 118, a short distance communication unit 101, a short distance communication control unit 102, an input/output unit 105, a control unit 107, an antenna 121, an antenna 122, an input unit 112, a display unit 113, a decoding unit 109, and an authentication unit 103.

The mobile telephone 100 is specifically a computer system composed of a microprocessor, a signal processor, a ROM, a RAM, and the like. The mobile telephone 100 achieves part of its functions by the microprocessor and the signal processor operating according to computer programs stored in the mobile telephone 100.

(1) Antenna 121, Telephone Communication Unit 115, and Telephone Communication Control Unit 116

The antenna 121, the telephone communication unit 115, and the telephone communication control unit 116 perform transmission/reception of sound and/or information with an apparatus that is connected to the mobile telephone 100.

The telephone communication unit 115 is composed of a reception unit and a transmission unit. The reception unit is composed of a high frequency amplifier, a reception mixer, an IF amplifier, a demodulator, and so on, and has a function of amplifying and demodulating a signal received by the antenna 121. The transmission unit is composed of a transmission power amplifier, a transmission mixer, a modulator, and so on, and has a function of modulating a high frequency signal according to a baseband signal, converting the output thereof to a radio frequency, amplifying the radio frequency signal, and outputting the amplified radio frequency signal via the antenna 121. The telephone communication control unit 116 includes a baseband unit, and performs processing of various signals input/output to/from the telephone communication unit 115.

(2) Short Distance Communication Control Unit 102, Short Distance Communication Unit 101, Antenna 122

The antenna 122, the short distance communication unit 101, and the short distance communication control unit 102 transmit/receive information with the automated ticket barriers 400, 420, 430 . . . by radio communication using a frequency band of 2.4 GHz.

The short distance communication unit 101 includes a transmission/reception unit that transmits and receives signals via the antenna 122, and a modulation/demodulation unit that modulates and demodulates signals. The short distance communication control unit 102 processes various signals input/output to/from the short distance communication unit 101.

(3) Input/Output Unit 105

The input/output unit 105 is connected to the memory card 300, and performs transmission/reception of information between memory card 300 and the control unit 107, and between the memory card 300 and the authentication unit 103.

(4) Input Unit 112 and Display Unit 113

The input unit 112 includes various keys such as numeric keys, an OK key and a selection key, and receives instructions and information from the user according to operations of the keys by the user.

The display unit 113 displays various information under the control of the control unit 107.

(5) Authentication Unit 103

The authentication unit 103 stores a secret key, a public key certificate, a public key, and a CRL. The secret key is unique to the mobile telephone 100. The public key certificate includes the public key that is a pair with the secret key. The public key is the public key of the certificate authority that issued the public key certificate. The CRL includes one or more certificate IDs of revoked public key certificates.

Upon the memory card 300 being mounted in the mobile telephone 100, the authentication unit 103 performs device authentication with the authentication unit 303 of the memory card 300, and generates a common session key.

(6) Control Unit 107

The control unit 107 includes an internal clock that counts time.

When device authentication by the authentication unit 103 fails, the control unit 107 does not perform transmission/reception of information with the memory card 300. When device authentication succeeds, in subsequent communication with the memory card 300, the control unit 107 performs secret communication using the session key generated in the device authentication by the authentication unit 103. Note that a description of encryption and decryption using the session key is omitted.

The control unit 107 also receives operation instruction information corresponding to a user operation from the input unit 112. When operation instruction information showing playback of content is received after device authentication by the authentication unit 103 succeeds, the control unit 107 performs content playback processing as follows.

(Content Playback Processing)

Upon receiving operation instruction information showing playback of content, from the input unit 112 while the memory card 300 is in a mounted state in the mobile telephone 100, the control unit 107 acquires the current time from the internal clock, and transmits a content request signal and the acquired current time to the memory card 300.

Next, the control unit 107 receives a playback key, an encrypted content key, and encrypted content from the memory card 300 via the input/output unit 105. Alternatively, if the content cannot be played because entry processing has not been performed, the control unit 107 receives an error signal showing that the content cannot be played. When an error signal is received, the control unit 107 generates a screen to notify that user that the content cannot be played, instructs the display unit 113 to display the generated screen, and does not perform subsequent processing.

When the playback key, the encrypted content key and the encrypted content are received, the control unit 107 subjects the encrypted content key to a decryption algorithm D2 using the playback key, thereby generating a content key. The control unit 107 outputs the generated content key and the received encrypted content to the decoding unit 109, and instructs the decoding unit 109 to play the content. Specifically, the control unit 107 successively receives the blocks that make up the encrypted content from the memory card 300 in order staring from the first block, and successively outputs the received encrypted content to the decoding unit 109. Here, the D2 is an algorithm for decrypting a cipher text generated using the encryption algorithm E2.

When operation instruction information showing that playback is to be stopped is received from the input unit 112, or when all of the blocks of the encrypted content have been output, the control unit 107 acquires the current time from the internal clock, and transmits the acquired time and a playback end signal to the memory card 300 via the input/output unit 105.

When output of the blocks of the encrypted content from the memory card 300 is forcedly interrupted and a request for the current time is received from the memory card 300, the control unit acquires the current time from the internal clock, and transmits the acquired current time to the memory card 300 via the input/output unit 105.

(Entry Processing and Exit Processing)

When the memory card 300 and the automated ticket barrier 400 perform entry processing and exit processing, the control unit 107 outputs information received from the automated ticket barrier 400 via the antenna 122, the short distance communication unit 101 and the short distance communication control unit 102 to the memory card 300.

The control unit 107 also transmits information received from the memory card 300 to the automated ticket barrier 400 via the antenna 122, the short distance communication unit 101 and the short distance communication control unit 102.

(7) Decoding Unit 109

The decoding unit 109 receives a content key and encrypted content from the control unit 107, and subjects the encrypted content to a decryption algorithm D1 using the received content key, thereby generating content. Here, D1 is an algorithm for decrypting a ciphertext generating using the encryption algorithm E1.

Next, the decoding unit 109 expands the generated content, generates a screen and audio, and outputs the generated screen and audio via the display unit 113 and the speaker 118.

1.7 Automated Ticket Barriers 400, 420, 430, 500, 520, 530 . . .

The automated ticket barriers 400, 420, 430, 500, 520, 530 . . . are located at the entrance of a train station, and control entry and exiting of users.

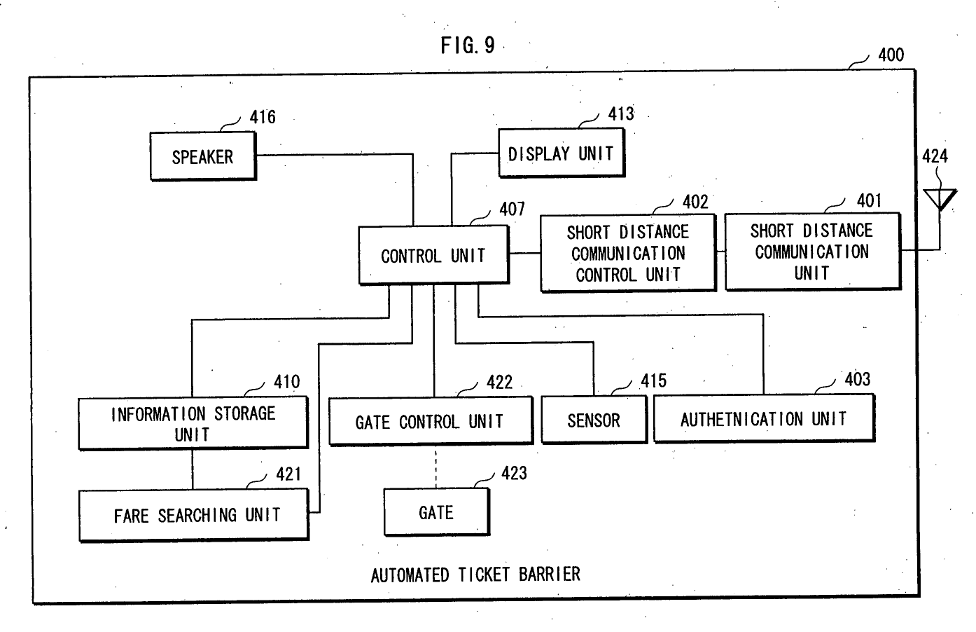

As shown in FIG. 9, the automated ticket barrier 400 is composed of a short distance communication unit 401, a short distance communication control unit 402, an antenna 424, a display unit 413, a speaker 416, an information storage unit 410, a fare searching unit 421, a control unit 407, a gate control unit 422, a gate 423, a sensor 415, and an authentication unit 403.

The automated ticket barrier 400 is a computer system, and more specifically, is composed of a microprocessor, a ROM, a RAM, and so on. Computer programs are stored in the RAM. The automated ticket barrier 400 achieves its functions by the microprocessor operating in accordance with the computer programs.

Note that since the automated ticket barriers 420, 430, 500 . . . have the same structure as the automated ticket barrier 400, a description thereof is omitted.

(1) Information Storage Unit 410

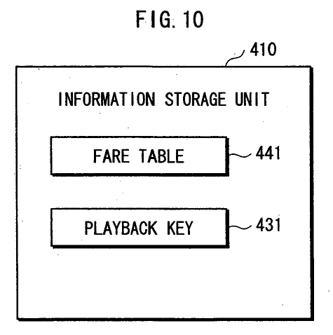

As shown in FIG. 10 as one example, the information storage unit 410 stores a fare table 441 and a playback key 431.

The playback key 431 is a secret key for decrypting the encrypted content key “ab0A” stored in the memory card 300. The playback key 431 is identical to the playback key 235 stored in the content management apparatus 200.

The fare table 441 shows fares for a train 35, and is composed of a plurality of fare information 442, 443, 444, 445 . . . Each fare information includes a boarding station and a plurality of fares. The boarding station is the name of a station where the user boards the train 35. Each fare is determined depending on the combination of the boarding station and a destination station. A fare 452 included in the fare information 442 shows that the fare in the case of the boarding station 451 being “Nishi-Umeda” and the destination station being “Higobashi” is 180 yen.

(2) Short Distance Communication Control Unit 402, Short Distance Communication Unit 401, Antenna 424

The short distance communication control unit 402, the short distance communication unit 401, and the antenna 424 transmit/receive information to/from the mobile telephone 100 by radio communication using a frequency band of 2.4 GHz.

The short distance communication unit 401 includes a transmission/reception unit the transmits and receives signals via the antenna 424, and a modulation/demodulation unit that modulates and demodulates signals. The short distance communication control unit 402 processes various signals input/output between the control unit 407 and the short distance communication unit 401.

Specifically, the antenna 424 is provided in two positions, one being pointed toward the inside of the station, and the other being pointed toward the outside of the station.

(3) Fare Searching Unit 421

The fare searching unit 421 stores the name of the station at which the automated ticket barrier 400 is located.

The fare searching unit 421 receives the boarding station from the control unit 407. Upon receiving the boarding station, the fare searching unit 421 reads the fare table 441 from the information storage unit 410, and from the read fare table 441, extracts the fare that corresponds to the combination of the boarding station and the destination station. Here, the destination station is the station name stored by the fare searching unit 421 itself. The fare searching unit 421 then outputs the extracted fare to the control unit 407.

(4) Authentication Unit 403

The authentication unit 403 stores a secret key, a public key certificate, a public key, and a CRL. The secret key is unique to the automated ticket barrier 400. The public key certificate includes the public key that is a pair with the secret key. The public key is the public key of the certificate authority that issued the public key certificate. The CRL includes one or more certificate IDs of revoked public key certificates.

The authentication unit 403 performs device authentication with an external apparatus under the control of the control unit 407, and shares a session key with the external apparatus.

(5) Control Unit 407

The control unit 407 stores the name of the station at which the automated ticket barrier 400 is located.

The control unit 407 regularly outputs a communication start signal via the short distance communication control unit 402, the short distance communication unit 401, and the antenna 424.

The control unit 407 detects the memory card 300 via the short distance communication control unit 402, the short distance communication unit 401, the antenna 424, and the mobile telephone 100. When the user passes through the automated ticket barrier 400 headed into the station, in other words, when a response signal is received from the antenna 424 pointed toward the outside of the station, the control unit 407 performs (i) entry processing. When the user passes through the automated ticket barrier 400 headed out of the station, in other words, when a response signal is received from the antenna 424 pointed toward the inside of the station, the control unit 407 performs (ii) exit processing.

The following describes (i) entry processing and (ii) exit processing.

(i) Entry Processing

Upon receiving a response signal showing that communication is possible from the memory card 300 via the antenna 424 that points toward outside the station, the control unit 407 instructs the authentication unit 403 to perform device authentication with the memory card 300.

If device authentication by the authentication unit 403 fails, the control unit 407 instructs the gate control unit 422 to close the gate, outputs an error display (e.g. has a red light illuminated) and a warning sound via the display unit 413 and the speaker 416, and stops subsequent processing.

When the device authentication by the authentication unit 403 succeeds, in transmission/reception of information with the memory card 300 described later, information transmitted/received by the control unit 407 is encrypted using the received session key before being transmitted, for brevity of explanation hereinafter, processing for encryption and decryption using the session key are not mentioned.

The control unit 407 reads the station name stored in the automated ticket barrier 400, and transmits the read station name as the boarding station to the memory card 300 via the short distance communication control unit 402, the short distance communication unit 401, the antenna 424, and the mobile telephone 100.

Next, the control unit 407 receives a playback request signal from the memory card 300 via the mobile telephone 100, the antenna 424, the short distance communication unit 401, and the short distance communication control unit 402. Upon receiving the playback key request signal, the control unit 407 reads the playback key 431 from the information storage unit 410, and transmits the read playback key 431 to the memory card 300 via the short distance communication control unit 402, the short distance communication unit 401, the antenna 424, and the mobile telephone 100.

Here, although the automated ticket barrier 400 is described as transmitting the boarding station and the playback key to the memory card 300, the automated ticket barrier 400 may also transmit a boarding date and time, and a boarding flag “1” showing that entry processing has taken place normally.

(ii) Exit Processing

Upon receiving a response signal showing that communication is possible from the memory card 300 via the antenna 424 that points inside the station, the control unit 407 instructs the authentication unit 403 to performs mutual device authentication with the memory card 300.

If device authentication by the authentication unit 403 fails, the control unit 407 instructs the gate control unit 422 to close the gate, outputs error display and a warning sound via the display unit 413 and the speaker 416, and stops subsequent processing.

When device authentication by the authentication unit 403 succeeds, in subsequent communication with the memory card 300, the control unit 407 performs secret communication using the session key generated in the device authentication by the authentication unit 403. Note that a description of encryption and decryption using the session key is omitted.

The control unit 407 transmits an account settlement start signal to the memory card 300 via the short distance communication control unit 402, the short distance communication unit 401, the antenna 424, and the mobile telephone 100.

Next, the control unit 407 receives an entry flag and a boarding station from the memory card 300 via the short distance communication control unit 402, the short distance communication unit 401, the antenna 424, and the mobile telephone 100. When the received entry flag is “0”, the control unit 407 treats this as entry processing not having been performed by the memory card 300, and instructs the gate control unit 422 to close the gate, outputs an error display and a warning sound via the display unit 413 and the speaker 416, and stops subsequent processing.

When the received entry flag is “1”, the control unit 407 treats this as entry processing having been performed by the memory card 300, and outputs the received boarding station to the fare searching unit 421. The control unit 407 then receives a fare from the fare searching unit 421, and transmits the received fare to the memory card 300 via the short distance communication control unit 402, the short distance communication unit 401, the antenna 424, and the mobile telephone 100.

Next, the control unit 407 receives an account settlement result from the memory card 300 via the short distance communication control unit 402, the short distance communication unit 401, the antenna 424, and the mobile telephone 100. When the received account settlement result is “0”, the control unit treats this as the electronic money balance in the memory card 300 being insufficient, and instructs the gate control unit 422 to close the gate, outputs an error display and a warning sound via the display unit 413 and the speaker 416, and stops subsequent processing.

When the received account settlement result is “1”, the control unit 407 then transmits a key deletion instruction to the memory card 300 via the short distance communication control unit 402, the short distance communication unit 401, the antenna 424, and the mobile telephone 100.

Next, the control unit 407 transmits an account settlement completion signal to the memory card 300 via the short distance communication control unit 402, the short distance communication unit 401, the antenna 424, and the mobile telephone 100.

At this time the control unit 407 may also transmit, for instance, an exit date and time, and a boarding flag “0” showing that exit processing has ended normally.

(6) Speaker 416, Display Unit 413, Sensor 415

The speaker 416 outputs various message sounds under the control of the control unit 407. The display unit 413 displays various information under the control of the control unit 407. The sensor 415 senses that a user is passing through the automated ticket barrier 400. More specifically, the sensor 415 has a plurality of light emitting units and a plurality of light receiving units that correspond respectively to the light emitting units, and detects the direction in which the user passes through the automated ticket barrier 400 (from inside the station to outside the station, or from outside the station to inside the station).

(7) Gate Control Unit 422 and Gate 423

The gate control unit 422 controls opening and closing of the gate 423 under the control of the control unit 407. The gate 423 opens and closes under the control of the gate control unit 422, thereby permitting the user to or preventing the user from passing through the automated ticket barrier 400.

1.8 Operations of the Location-Limited Content Usage System 1

The following describes operations of the location-limited content usage system 1 with use of the drawings.

(1) Electronic Money Deposit Processing

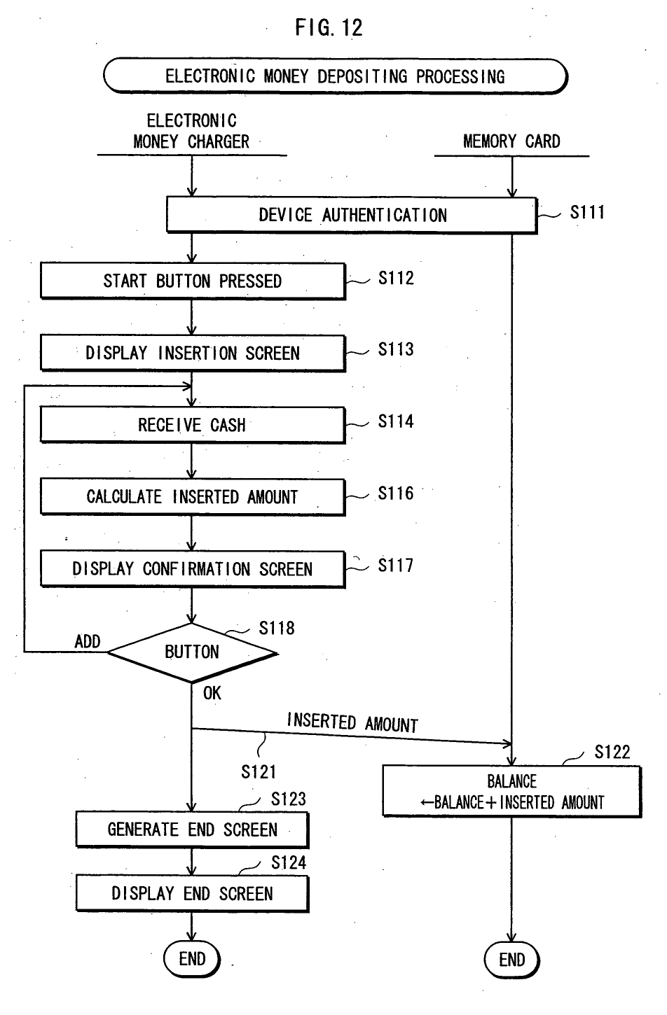

The following describes electronic money deposit processing by the electronic money charger 600 and the memory card 300, with use of the flowchart shown in FIG. 12.

Upon the memory card 300 being mounted in the electronic money charger 600 by the user, the electronic money charger 600 and the memory card 300 perform device authentication (step S111). When the device authentication fails, the electronic money charger 600 and the memory card 300 stop subsequent processing.

When the device authentication succeeds, the electronic money charger 600 receives a press of the start button by the user (step S112). Next, the electronic money charger 600 generates the money insertion screen 622 shown in FIG. 7, and displays the generated money insertion screen 622 on the display unit 613 (step S113). The electronic money charger 600 then receives cash inserted by the user (step S114), calculates the insertion amount (step S116), displays the confirmation screen 623 shown in FIG. 7 on the display unit 613 (step S117), and receives a user button operation (step S118). Upon receiving a press of the add button (step S118), the electronic money charger 600 returns to step S114, and repeats the processing at step 114 to step S118 until the OK button is pressed.

Upon receiving a press of the OK button (step S118), the electronic money charger 600 outputs the calculated insertion amount to the memory card 300 (step S121).

Next, the electronic money charger 600 generates the end screen 624 (step S123), and displays the generated end screen 624 on the display unit 613 (step S124).

The memory card 300 receives the inserted amount from the electronic money charger 600, and adds the received inserted amount to the electronic money balance 322 stored in the memory card 300 (step S122).

(2) Entry Processing

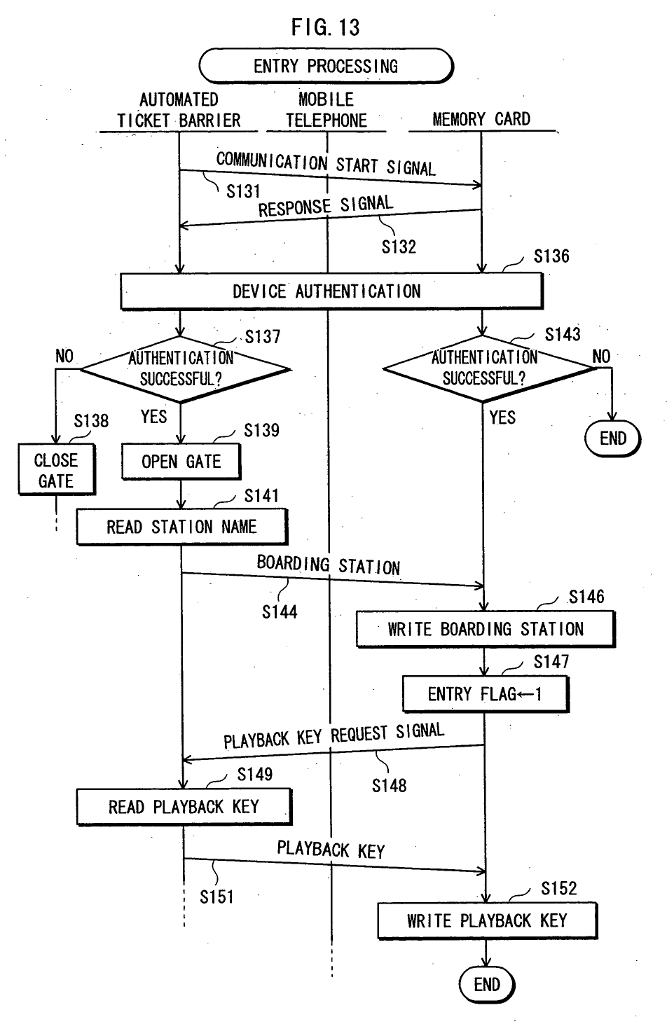

The following describes entry processing with use of the flowchart shown in FIG. 13.

The automated ticket barrier 400 transmits a communication start signal (step S131).

The memory card 300 receives the communication start signal from the automated ticket barrier 400 via the mobile telephone 100, and transmits a response signal to the automated ticket barrier 400 via the mobile telephone 100 (step S132).

The automated ticket barrier 400 receives a response signal from the memory card 300 via the antenna 424 that points outside the station, and the mobile telephone 100. Next, the automated ticket barrier 400 and the memory card 300 perform mutual authentication (step S136).

When mutual authentication fails (step S137), the automated ticket barrier 400 closes the gate (step S138), and stops subsequent processing.

When mutual authentication succeeds (YES at step S137), the automated ticket barrier 400 opens the gate (step S139). Note that if the gate is already open, step S139 is omitted.

Next, the automated ticket barrier 400 reads the station name stored in the automated ticket barrier 400 (step S141), and transmits the read station name, as the boarding station, to the memory card 300 (step S144).

When the mutual authentication fails (NO at step S143), the memory card 300 stops subsequent processing.

When the mutual authentication succeeds (YES at step S143), the memory card 300 receives the station from the automated ticket barrier 400 via the mobile telephone 100, writes the received station name to the secure area 321 of the information storage unit 310 (step S146), and sets the entry flag 332 to “1” (step S147).

Next, the memory card 300 transmits a playback key request signal to the automated ticket barrier 400 via the mobile telephone 100 (step S148).

The automated ticket barrier 400 receives the playback key request signal via the mobile telephone 100. Upon receiving the playback key request signal, the automated ticket barrier 400 reads the playback key 431 from the information storage unit 410 (step S149), and transmits the read playback key 431 to the memory card 300 via the mobile telephone 100 (step S151).

The memory card 300 receives the playback key from the automated ticket barrier 400 via the mobile telephone 100, and writes the received playback key to the secure area 321 of the information storage unit 310 (step S152).

(3) Content Playback by the Mobile Telephone 100

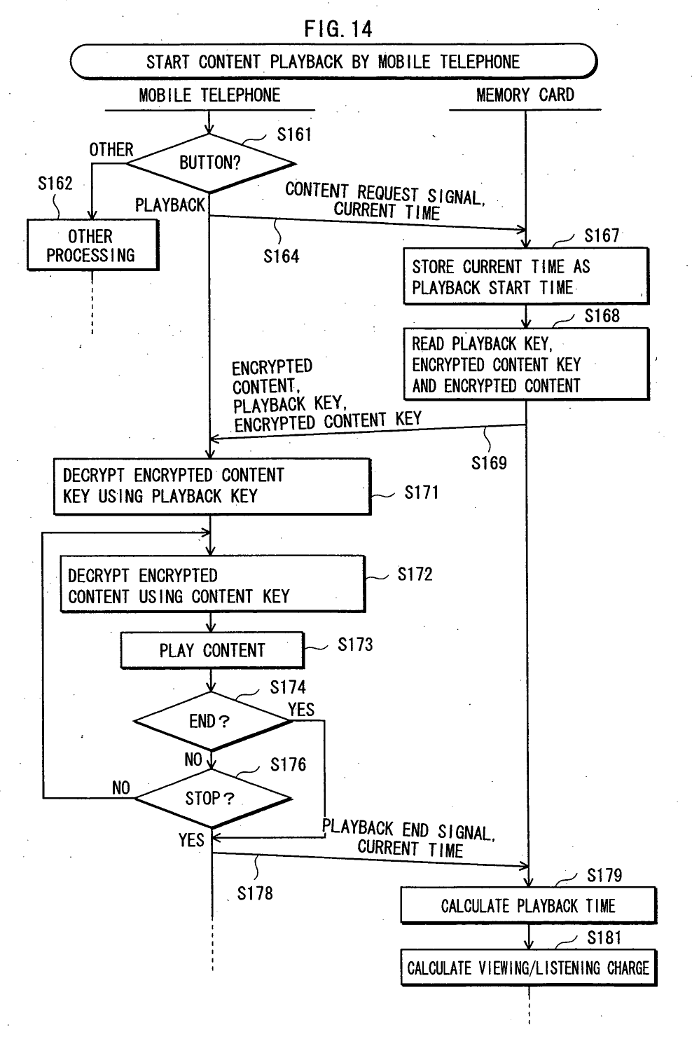

The following describes processing for content playback by the mobile telephone 100 with use of the flowchart shown in FIG. 14.

The mobile telephone 100 receives a user button operation (step S161). Upon receiving a button operation showing content playback (step S161), the mobile telephone 100 transmits the current time and a content request signal to the memory card 300 (step S164).

On receiving an operation of another button, the memory card 300 receives the current time and a content request signal from the mobile telephone 100, temporarily stores the received current time as the playback start time (step S167), and reads the encrypted content key “ab0A” included in the playback information 336, the playback key 323, and the encrypted content 335 from the information storage unit 310 (step S168). The memory card 300 then transmits the read playback key 323, encrypted content key “ab0A” and the encrypted content 335 to the mobile telephone 100 (step S169). More specifically, the memory card 300 successively reads the blocks of the encrypted content 335 in order from the first block, and transmits the read blocks to the mobile telephone 100.

The mobile telephone 100 receives the playback key, the encrypted content key, and the encrypted content from the memory card 300, and decrypts the received encrypted content key using the received playback key, thereby generating a content key (step S171).

The mobile telephone 100 decrypts the received encrypted content using the generated content key, thereby generating content (step S172). The mobile telephone 100 then plays the generated content by expanding the generated content, generating a screen and audio, and outputting the generated screen and audio (step S173).

Next, the mobile telephone 100 judges whether or not it has finished playing the content through to the end (step S174), and when it is judged that the playback has finished (YES at step S174), proceeds to the processing at step S178.

When it is judged that playback has not finished (NO at step S174), and the mobile telephone 100 further receives a button operation showing playback stop from the user (YES at step S176), the mobile telephone 100 transmits a playback end signal and the current time to the memory card 300 (step S178).

If a button operation showing playback stop is not received (NO at step S176), the mobile telephone 100 either ends playback of the content, or repeats the processing at step S172 to step S176 until a button operation showing playback stop is received.

The memory card 300 receives the playback end signal and the current time from mobile telephone 100, and using the received current time as the playback end time, calculates a playback time from the stored playback start time and the playback end time (step S179). Next, the memory card 300 finds the product of the playback time and the charge “5.0” included in the playback information 336 stored in the information storage unit 310, and adds the found product to the viewing/listening charge 0.339 (step S181).

(4) Exit Processing

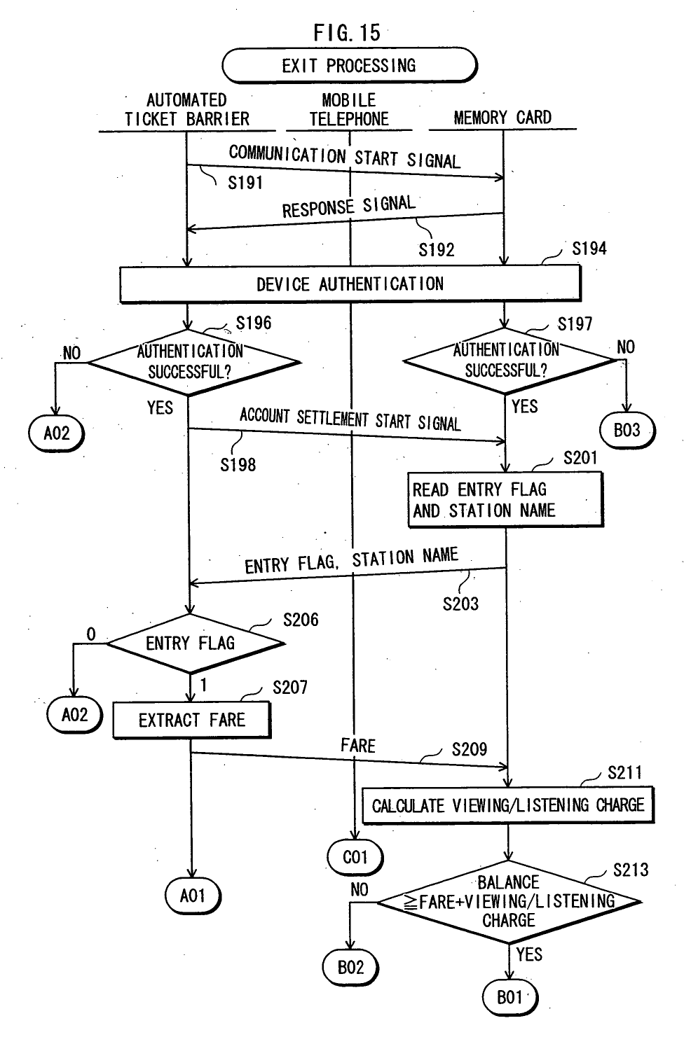

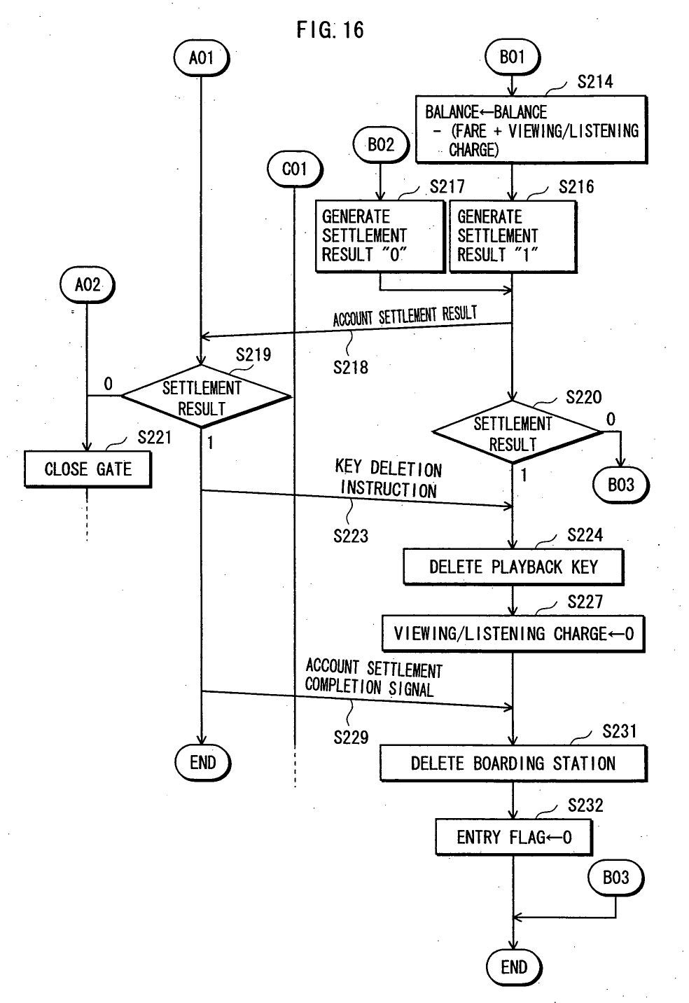

The following describes exit processing by the automated ticker barrier 400 and the memory card 300 with use of the flowchart showing in FIG. 15 and FIG. 16.

The automated ticket barrier 400 transmits a communication start signal to the memory card 300 via the mobile telephone 100 (step S191).

The memory card 300 receives a communication start signal from the automated ticket barrier 400 via the mobile telephone 100, and upon receiving the communication start signal, transmits a response signal via the mobile telephone 100 (step S192).

The automated ticket barrier 400 receives the response signal from the memory card 300 via the mobile telephone 100, and performs device authentication with the memory card 300 (step S194).

When device authentication fails (NO at step S196), the automated ticket barrier 400 moves to the processing at step S221.

When device authentication succeeds (YES at step S196), the automated ticket barrier 400 transmits an account settlement start signal to the memory card 300 via the mobile telephone 100 (step S198).

When the device authentication fails (NO at step S197), the memory card 300 stops subsequent processing.

When device authentication succeeds (YES at step S197), the memory card 300 receives the account settlement start signal from the automated ticket barrier 400 via the mobile telephone 100. Upon receiving the account settlement start signal, the memory card 300 reads the entry flag 332 and the boarding station 333 (step S201), and transmits the read entry flag, 332 and boarding station 333 to the automated ticket barrier 400 via the mobile telephone 100 (step S203). Here, in the case of the boarding station 333 not existing in the information storage unit 310, the memory card 300 transmits “000” as the boarding station.

The automated ticket barrier 400 receives the entry flag and station name from the memory card 300 via the mobile telephone 100, and determines which of “0” and “1” the received entry flag is (step S206). When the entry flag is “0” (“0” at step S206), the automated ticket barrier 400 moves the processing to step S221.

When the entry flag is “1” (“1” at step S206), the automated ticket barrier 400 extracts a fare corresponding to the combination of the received boarding station and the destination station from the fare table 441, the destination station being the station name stored in the automated ticket barrier 400 (step S207), and transmits the extracted fare to the memory card 300 via the mobile telephone 100 (step S209).

The memory card 300 receives the fare from the automated ticket barrier 400 via the mobile telephone 100. Upon receiving the fare, the memory card 300 reads the viewing/listening charge 339 from the information storage unit 310 (step S211), calculates the total of the received fare and the read viewing/listening charge 339, and compares the calculated total and the electronic money balance 322 stored in the information storage unit 310 (step S213).

When the electronic money balance 322 is equal to or greater than the calculated total (YES at step S213), the memory card 300 subtracts the calculated total from the electronic money balance 322 (step S214), and then generates an account settlement result “1” (step S216).

When the calculated total is less than the electronic money balance 322 (NO at step S213), the memory card 300 generates an account settlement result “0” (step S217).

Next, the memory card 300 transmits the generated account settlement result to the automated ticket barrier 400 via the mobile telephone 100 (step S218).

The automated ticket barrier 400 receives the account settlement result from the memory card 300 via the mobile telephone 100, and when the received account settlement result is “0” (“0” at step S219), closes the gate (step S221).

When the received account settlement result is “1” (“1” at step S219), the automated ticket barrier 400 transmits a key deletion instruction to the memory card 300 via the mobile telephone 100 (step S223).

When the generated account settlement result is “0” (“0” at step S220), the memory card 300 stops subsequent processing.

When the generated account settlement result is “1” (“1” at step S220), the memory card 300 then receives the key deletion instruction from the automated ticket barrier 400 via the mobile telephone 100, and deletes the stored playback key 323 from the secure area 321 of the information storage unit 310 (step S224). The memory card 300 then initializes the viewing/listening charge 339 to “0” (step S227).

Next, the automated ticket barrier 400 transmits an account settlement completion signal to the memory card 300 via the mobile telephone 100 (step S229).

The memory card 300 receives the account settlement completion signal from the automated ticket barrier 400 via the mobile telephone 100. Upon receiving the account settlement completion signal, the memory card 300 deletes the boarding station 333 from the information storage unit 310 (step S231), and sets the entry flag 332 to “0” (step S232).

(5) Device Authentication

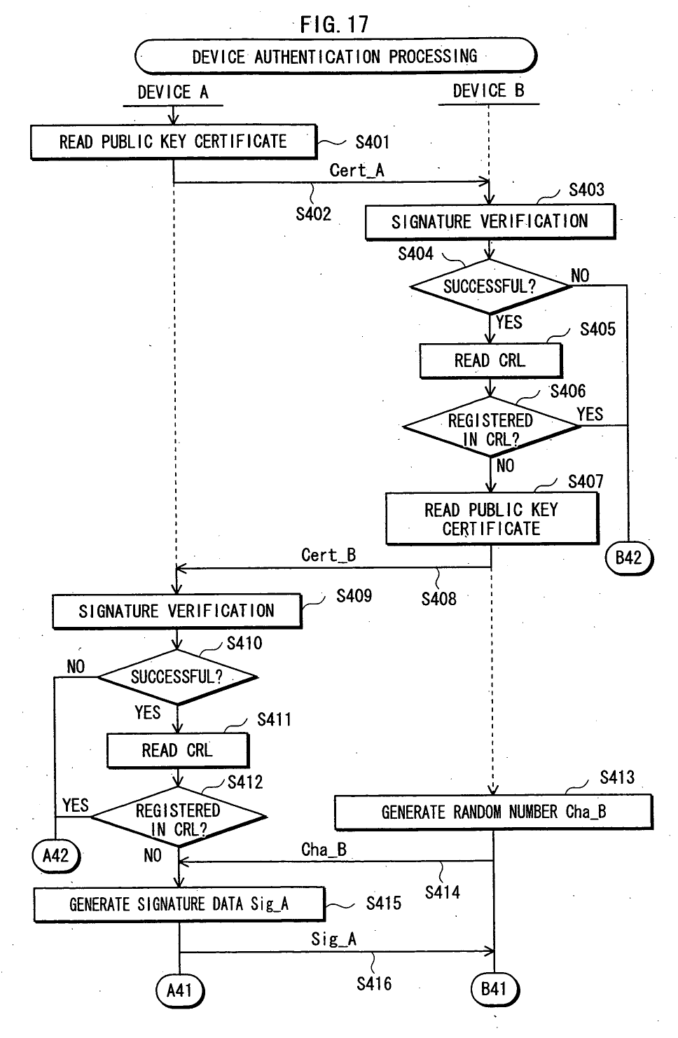

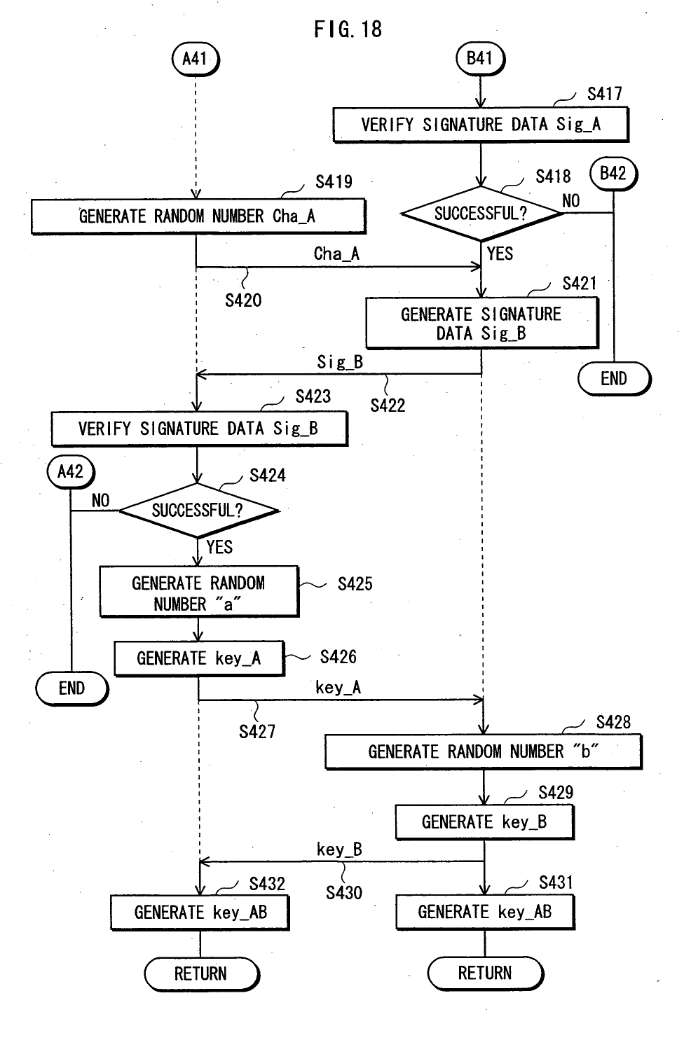

The following describes operations for device authentication between two devices using the flowchart shown in FIG. 17 to FIG. 18.

Note that this mutual authentication method is simply one example, and other another authentication method or key sharing method may be used. Furthermore, the device authentication is described as being performed by a device A and a device B, since the device authentication is performed between the content management apparatus 200 and the memory card 300, between the electronic money charger 600 and the memory card 300, between the mobile telephone 100 and the memory card 300, and between the automated ticket barrier 400 and the memory card 300.

Here, Gen( ) is a key generation function, and Y is a system unique parameter. It is assumed that the key generation function Gen( ) fulfills a relationship Gen(x, Gen(z,Y))=Gen(z,Gen(x,Y)). Since an arbitrary commonly known technique can be used for the key generation function, a detailed description thereof is omitted here.

The device A reads a public key certificate Cert_A (step S401), and transmits the read public key certificate Cert_A to the device B (step S402).

Having received the public key certificate Cert_A, the device B subjects certification authority signature data Sig_CA to a signature verification algorithm V using a certification authority public key PK_CA, to perform signature verification (step S403). Note that the certification authority signature data Sig_CA is received in the public key certificate Cert_A. Furthermore, the signature verification algorithm V is an algorithm for verifying signature data generated according to a signature generation algorithm S. When the result of signature verification is failure (NO at step S404), the processing ends.

When the result of signature verification is success (YES at step S404), the device B reads the CRL (step S405), and judges whether or not an ID number ID_A received in the public key certificate Cert_A is registered in the CRL (step S406). When it is judged that the public key certificate Cert_A is registered in the CRL (YES at step S406), the device-B ends the processing.

When it is judged that the public key certificate Cert_A is not registered in the CRL (NO at step S406), the device B reads a public key certificate Cert_B (step S407), and transmits the read public key certificate Cert_B to the device A (step S408).

Having received the public key certificate Cert_B, the device A subjects the certification authority signature data Sig_CA, which was received in the public key certificate Cert_B, to the signature verification algorithm V using the certificate authority public key PK_CA, to perform signature verification (step S409). If the result of signature verification is failure (NO at step S410), the processing ends.

When the result of signature verification is success (YES at step S410), the device A reads the CRL (step S411), and judges whether or not an ID number ID_B received in the public key certificate Cert_B is registered in the CRL (step S412). When it is judged that the public key certificate Cert_B is registered in the CRL (YES at step S412), the device A ends the processing. When it is judged that the public key certificate Cert_B is not registered in the CRL (NO at step S412), the device A continues the processing.

The device B generates a random number Cha_B (step S413), and transmits the generated random number Cha_B to the device A (step S414).

The device A receives the random number Cha_B, and subjects the received random number Cha_B to the signature generation algorithm S using a secret key SK_A of the device A, thereby generating signature data Sig_A (step S415). The device A then transmits the generated signature data Sig_A to the device B (step S416).

Upon receiving the signature-data Sig_A, the device B subjects the received signature data Sig_A to the signature verification algorithm V using a public key PK_A (step S417). Note that the public key PK_A is received in the public key certificate Cert_A. When the result of signature verification is failure (NO at step S418), the device B ends the processing. When the result of signature verification is success (YES at step S418), the device B continues the processing.

The device A generates a random number Cha_A (step S419), and transmits the generated random number Cha_A to the device B (step S420).

The device B receives the random number Cha_A, and subjects the received random number Cha_A to the signature generation algorithm S using the secret key SK_B of the device B, thereby generating signature data Sig_B (step S421), and transmits the generated signature data Sig_B to the device A (step S422).

Upon receiving the signature data Sig_B, the device A subjects the received signature data Sig_B to the signature verification algorithm V using the public key PK_B of the device B, to perform signature verification (step S423). Note that the public key PK_B is received in the public key certificate Cert_B. When the result of signature verification is failure (NO at step S424), the device A ends the processing. When the result of signature verification is success (YES at step S424), the device A then generates a random number “a” (step S425), generates a Key_A=Gen(a,Y) using the generated random number “a” (step S426), and transmits the generated Key_A to the device B (step S427).

Upon receiving the Key_A, the device B generates a random number “b” (step S428), generates Key_B=Gen(b,Y) using the generated random number “b” (step S429), and transmits the generated Key_B to the device A (step S430).

Furthermore, using the generated random number “b” and the received Key_A, the device B generates Key_AB=Gen (b, Key_A)=Gen (b, Gen(a,Y), which is the session key (step S431).

The device A receives the Key_B, and using the generated random number “a” and the received Key_B, generates Key_AB=Gen(a,Key_B)=Gen(a,Gen(b,Y), which is the session key (step S432).

1.9 Summary

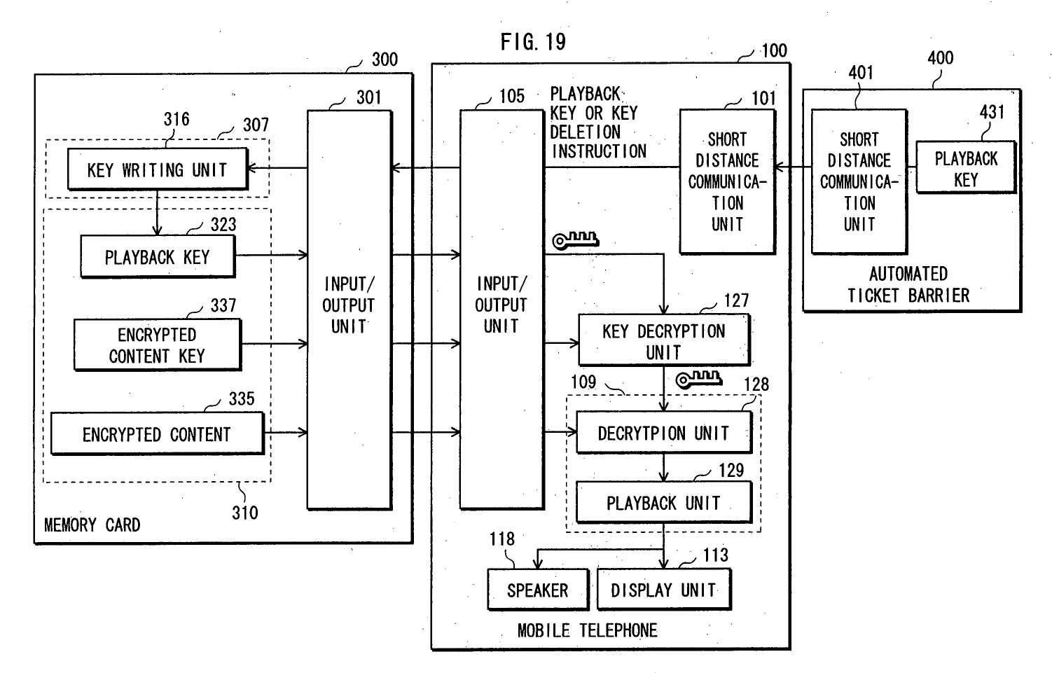

FIG. 19 shows the follow of transmission/reception of information between devices in the present embodiment.

When the user enters a station carrying the mobile telephone 100 with the memory card 300 in a mounted state therein, the automated ticket barrier 400 reads the playback key 431, and transmits the read playback key to the memory card 300 via the mobile telephone 100. When the user leaves a station, the automated ticket barrier 400 transmits a key deletion instruction to the memory card 300 via the mobile telephone 100.

A key writing unit 316, which is part of the control unit 307, receives the playback key 323 from the automated ticket barrier 400 via the input/output unit 301 and the mobile telephone 100, and writes the received playback key 323 to the information storage unit 310. Furthermore, the key writing unit 316 receives the key deletion instruction from the automated ticket barrier 400, and deletes the playback key 323.

Upon receiving a button instruction from the user instructing playback of content, the mobile telephone 100 reads the playback key 323, the encrypted content key 337 and the encrypted content 335 from the memory card 300.

A key decryption unit 127, which is part of the control unit 107, reads the playback key and the encrypted content from the memory card 300 via the input/output unit 105, decrypts the encrypted content key using the read playback key, thereby generating a content key, and outputs the generated content key to a decryption unit 128.

The decryption unit 128 and a playback unit 129 are part of the decoding unit 109.

The decryption unit 128 reads the encrypted content from the memory card 300, and receives the content key from the key decryption unit 127. The decryption unit 128 decrypts the encrypted content using the received content key, thereby generating content, and outputs the generated content to the playback unit 129.

The playback unit 129 receives the content from the decryption unit 128, expands the received content to generate a screen and audio, and outputs the generated screen and audio to the display unit 113 and the speaker 118.

When the memory card 300 does not store the playback key 323, the mobile telephone 100 is unable to play the content because it cannot generate the content key.

In this way, the mobile telephone 100 is able to play content only inside a station and a train. Furthermore, as described above, by having transfer of the playback key performed together with transmission the boarding station name, and having deletion of the playback key performed together with account settlement for the train fare using electronic money, the stored playback key can be deleted reliably from the memory card 300. This prevents dishonest playback of content, in other words, playback of content in positions other than the station and the train.

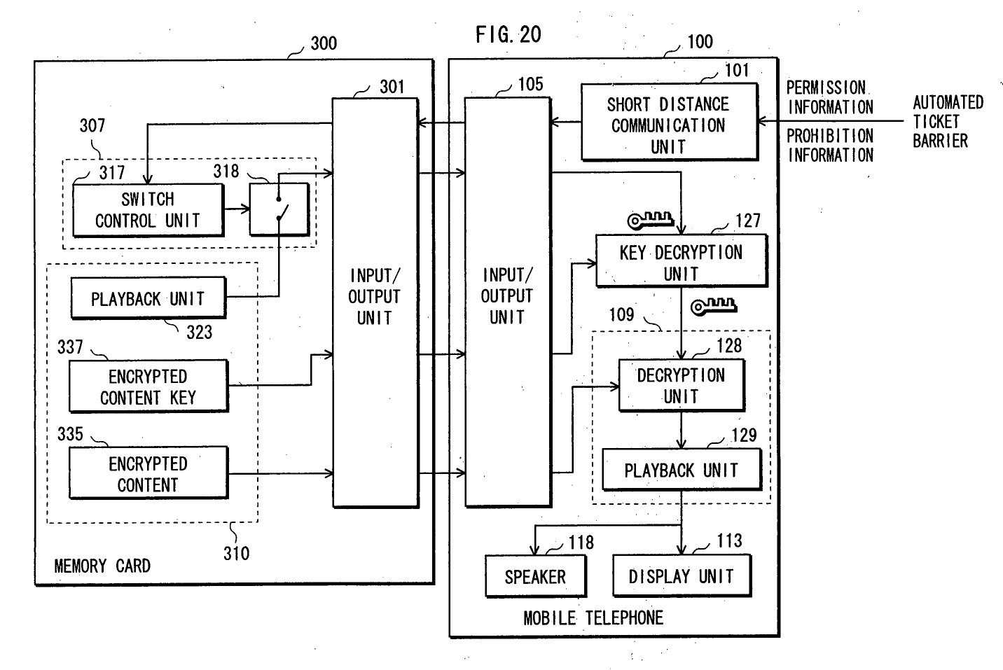

Note that although the playback key is transmitted from the automated ticket barrier 400 to the memory card 300 in the above description, the memory card 300 may instead store the playback key in advance as shown in FIG. 20.

As shown in FIG. 20, in this case, when the user enters a station carrying the mobile telephone 100 with the memory card 300 in a mounted state therein, the automated ticket barrier 400 transmits permission information showing that playback of the content is permitted, to the memory card 300 instead of transmitting the playback key. Furthermore, when the user leaves a station, the automated ticket barrier 400 transmits prohibition information showing that playback of the content is prohibited, to the memory card 300 instead of transmitting the key deletion instruction.

The control unit 307 of the memory card 300, includes a switch control unit 317 and a switch 318. The input/output unit 301 receives permission information or prohibition information from the automated ticket barrier 400 via the mobile telephone 100. When permission information is received, the switch control unit 317 closes the switch 318 such that the playback key 323 is readable. When prohibition information is received, the switch control unit 317 opens the switch 318 such that the playback key 323 is unreadable.

Note that the switch 318 may be a physical switch, or may be a switch flag stored in the control unit 307. For instance, if the switch flag is “1”, reading of the playback key 323 is permitted, and if the switch flag is “0”, reading of the playback key 323 is prohibited.

The mobile telephone 100 reads the playback key 323, the encrypted content key 337, and the encrypted content 335 from the memory card 300.

The key decryption unit 127 in the control unit 107 reads the playback key and the encrypted content key from the memory card 300 via the input/output unit 105, decrypts the encrypted content using the read playback key, thereby generating a content key, and outputs the generated content key to the decryption unit 128.

The decryption unit 128 reads the encrypted content from the memory card 300, and receives the content key from the key decryption unit 127. Using the received content key, the decryption unit 128 decrypts the encrypted content, thereby generating content, and outputs the generated content to the playback unit 129.

The playback unit 129 receives the content from the decryption unit 128, expands the received content, generates a screen and audio, and outputs the generated screen and audio to the display unit 113 and the speaker 118.

Since the mobile telephone 100 is unable to read the playback key when the switch 318 of the memory card 300 is open, it cannot generate the content key and play the content.

In this way, the mobile telephone 100 is able to play the content only inside the station and inside the train. Furthermore, since transmission/reception of the playback key does not take place between the automated ticket barrier 400 and the memory card 300, dishonest playback of the content by interception of the playback key can be prevented.

### 2. Second Embodiment

The following describes a area-limited content usage system 2 as an embodiment of the present invention.

2.1 Area-Limited Content Usage System 2

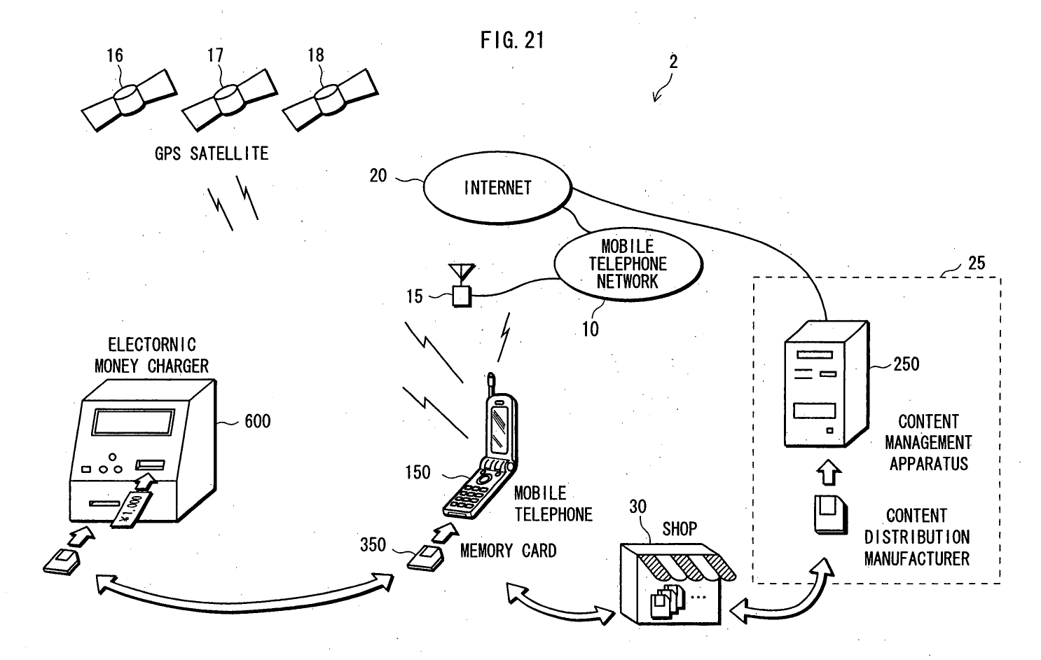

As shown in FIG. 21, the area-limited content usage system 2 is composed of a mobile telephone 150, a content management apparatus 250, the electronic money charger 600, and GPS satellites 16, 17, 18 . . .

The content management apparatus 250 possessed by the content distribution manufacturer 25 is connected to the Internet 20. Furthermore, the mobile telephone 150 is connected to the Internet 20 via the mobile telephone network 10 and the base station 15.

The content management apparatus 250 stores content, examples of which are movies and television programs composed of audio and video, and books composed text data. The content management apparatus 250 also stores content keys that differ per content, and encrypted content that has been generated by encrypting the content.

The content management apparatus 250 also stores viewing/listening areas, each of which shows a area in which content is permitted to be viewed/listened to.

Using the content management apparatus 250, the content distribution manufacturer 25 writes playback information that includes encrypted content, a content key and a viewing/listening area, to the memory card 350.

A user purchases the memory card 350 that has been dispatched by the content distribution manufacturer 25, via the shop 30.

The mobile telephone 150 receives a ranging signal from one of the GPS satellites, and based on the received ranging signal, calculates the latitude and longitude of the position at which the mobile telephone 150 is at the present. Note that the memory card 350 is able to be mounted in the mobile telephone 150.

The mobile telephone 150 is able to read the encrypted content from the memory card 350, and hence decrypt the encrypted content and play the content, only when the position shown by the latitude and longitude calculated by the mobile telephone 150 is within the viewing/listening area stored in the memory card 350.

Note that in the present embodiment, each device, when performing transmission/reception of information, performs mutual device authentication, generates a shared session key, and performs secret communication using the generated session key. However, for brevity of explanation hereinafter, processing for encryption and decryption using the session key are not mentioned.

2.2 Content Management Apparatus 250

The content management apparatus 250 is composed of a content information storage unit 261, a transmission/reception unit 201, an input/output unit 205, a control unit 257, an authentication unit 203, an input unit 212, and a display unit 213.

Specifically, the content management apparatus 250 is composed of a microprocessor, a RAM, a ROM, and a hard disk. Computer programs are stored in the RAM, the ROM and the hard disk, and the content management apparatus 250 achieves part of its functions by the microprocessor operating according to the computer programs.

The structure and operations of the transmission/reception unit 201, the input/output unit 205, the authentication unit 203, the input unit 212 and the display unit 213 are the same as the transmission/reception unit 201, the input/output unit 205, the authentication unit 203, the input unit 212 and the display unit 213 in the content management apparatus 200 of the first embodiment, and therefore a description thereof is omitted here.

(1) Content Information Storage Unit 261

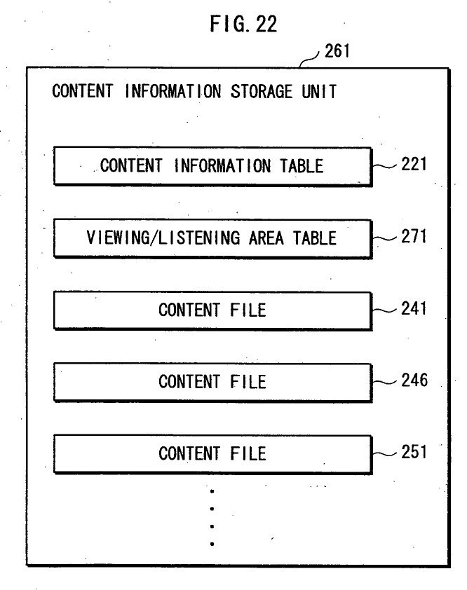

The content information storage unit 261 is composed of a hard disk unit, and, as shown in FIG. 22, stores a content information table 221, a viewing/listening area table 271, and content files 241, 246, 251 . . .

The content information table 221 and the content files 241, 246, 251 . . . are the same as in the first embodiment, and therefore a description thereof is omitted here.

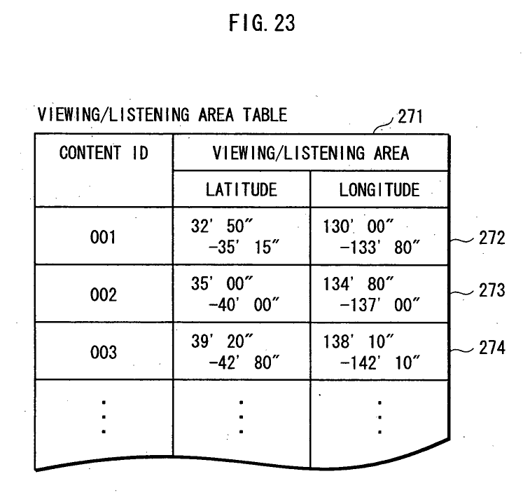

As shown in FIG. 23, the viewing/listening area table 271 is composed of a plurality of viewing/listening area information 272, 273, 274 . . . , each of which includes a content ID and a viewing/listening area. The viewing/listening area shows a area in which the corresponding content can be viewed/listened to, and includes latitudes and longitudes. For instance, viewing/listening area information 272 shows that content identified by a content ID “001” can be viewed/listened to in a area of latitude “32′ 50″ to 35′ 15″” and longitude “130′ to 00″ to 133′ 80″”.

(2) Control Unit 257

The control unit 257 receives various instructions and information from the user via the input unit 212.

When device authentication between the authentication unit 203 and the authentication unit 353 of the memory card 350 succeeds, and a content ID “001” and a content write instruction are received via the input unit 312, the control unit 257 selects, from the content information table 221, the content information 222 that includes the received content ID “001”, and extracts the file name 2 “FILAB” included in the selected content information 222. Based on the extracted file name 2 “FILAB”, the control unit 257 selects the content file 246, reads the encrypted content 248 included in the selected content file 246, and writes the read encrypted content 248 to a general area 381 of the memory card 350 via the input/output unit 205.

Next, the control unit 257 extracts the content key “AB01” from the selected content information 222, and writes the extracted content key “AB01” to a secure area 371 of the memory card 350.

Next, based on the received content ID “001”, the control unit 257 selects the viewing/listening area information 272 from the viewing/listening area table 271. The control unit 257 extracts the content ID “001” and the charge “5.0” from the selected content information 222, extracts the viewing/listening area from the selected viewing/listening area information 272, and writes the extracted content ID “001”, charge “5.0” and viewing/listening area to the secure area 371 of the memory card 350 as playback information.

2.3 Memory Card 350

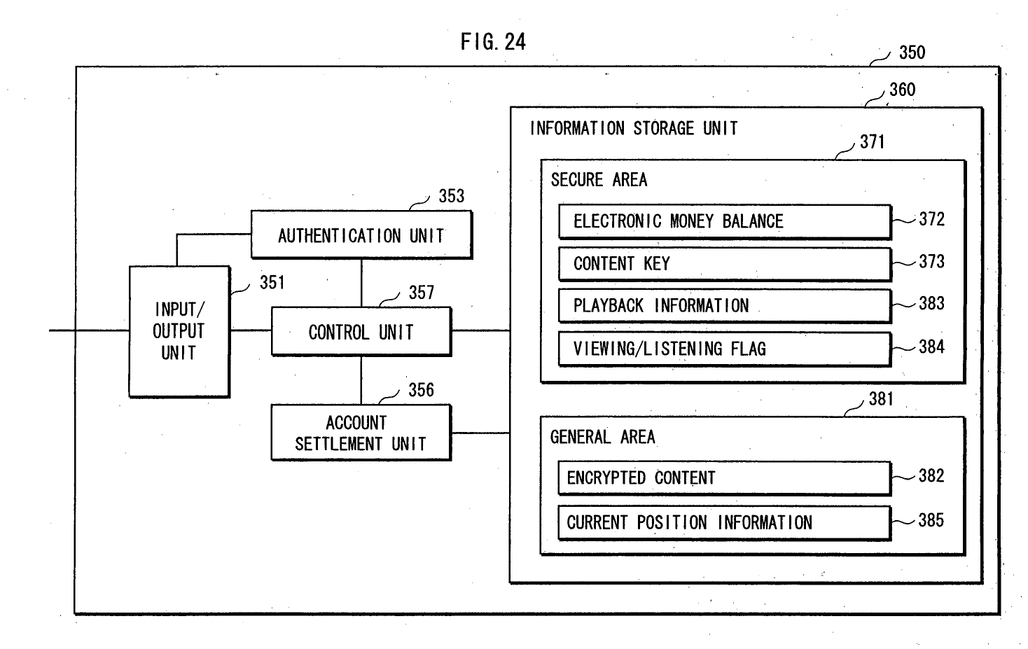

As shown in FIG. 24, the memory card 350 is composed of an input/output unit 351, an authentication unit 353, a control unit 357, an account settling unit 356, and an information storage unit 360.

The memory card 350 is specifically a computer system composed of a microprocessor, a RAM, and an EEPROM and the like. Computer programs are stored in the RAM and the EEPROM, and the memory card 350 achieves part of its functions by the microprocessor operating in accordance with the programs.

The structure and operations of the input/output unit 351 and the authentication unit 353 are the same as the input/output unit 301 and the authentication unit 303 of the memory card 300 in the first embodiment, and therefore a description thereof is omitted here.

(1) Information Storage Unit 360

The information storage unit 360 is composed of a nonvolatile writable storage device such as an EEPROM, and includes a secure area 371 and a general area 381. Only a device that succeeds in device authentication with the authentication unit 353 can use the information in the secure area 371.

As one example, the secure area 371 stores an electronic balance 372, a content key 373, playback information 383, and a viewing/listening flag 384, and the general area 381 stores encrypted content 382 and current position information 385.

The electronic money balance 372 is the amount of electronic money stored in the memory card 350. The content key 373 is a key value for decrypting the encrypted content 382, and is identical to the content key “AB01” included in the content information 222 stored in the content management apparatus 250.

The encrypted content 382 is, as one example, encrypted content generated by encrypting content such as a movie or television program, and is identical to the encrypted content 248 stored in the content management apparatus 250.

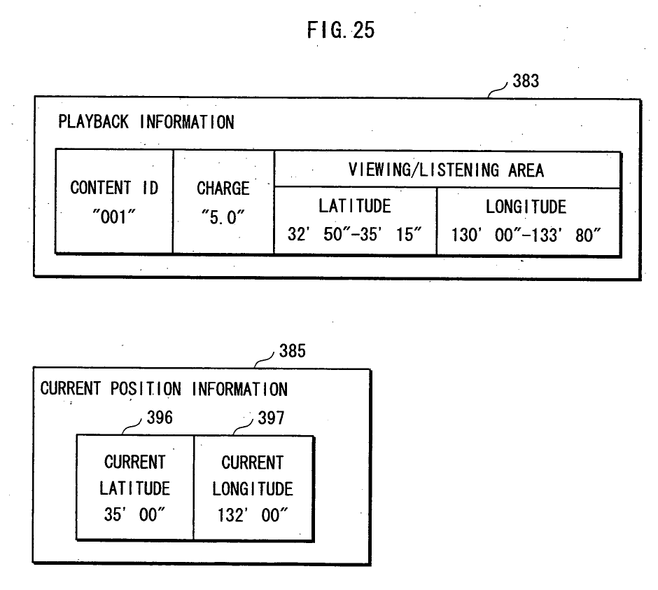

As shown in FIG. 25, the playback information 383 is composed of a content ID “001” and a viewing/listening area, the viewing/listening area including latitude “32′ 50″ to 35′ 15″” and longitude “130′ 00″ to 133′ 80″”. The content ID “001” is identification information corresponding to the content generated by decrypting the encrypted content 382. The amount “5.0” shows a monetary amount for viewing/listening to content shown by the content ID “001”, and is expressed in units of yen per minute.

The viewing/listening area indicates that the content shown by the content ID “001” is viewable/listenable within a area corresponding to latitude “32′ 50″-35′ 15″” and longitude “130′ 00″-133′ 80″”. The content ID “001”, the charge “5.0” and the viewing/listening area are identical to the content ID, the charge and the viewing/listening area included in the content information 222 and the viewing/listening area information 272 stored in the content management apparatus 250.

The viewing/listening flag 384 expresses whether or not the memory card 350 is in the viewing/listening area. The viewing/listening flag 384 being “0” shows that the memory card 350 is outside the viewing/listening area, and the viewing/listening flag being “1” shows that the memory card 350 in within the viewing/listening area.

The current position information 385 is the current position of the memory card 350, and as shown in FIG. 25, includes a current latitude 396 and a current longitude 397. The current position information 385 shown in FIG. 25 shows, as one example, that currently the memory card 350 exists at a position having a latitude “35′ 00″” and a longitude “132′ 00″”.

(2) Account Settlement Unit 356

The account settlement unit 356 receives an insertion amount and an instruction to perform account settlement from the control unit 357. The account settlement unit 356 also receives a playback time and an instruction to perform account settlement from the control unit 357.

Upon receiving an insertion amount and an instruction to perform account settlement from the control unit 357, the account settlement unit 356 reads the electronic money balance 322 stored in the secure area 371 of the information storage unit 360, adds the received insertion amount to the read electronic money balance 372, and overwrites the electronic money balance 322 in the secure area 371 with the electronic money balance obtained as a result of the addition. The account settlement unit 356 then outputs an end signal, to the control unit 357, showing that account settlement of the electronic money ended normally.

Upon receiving the playback time and the instruction to perform account settlement, the account settlement unit 356 extracts the amount “5.0” from the playback information 383 stored in the secure area 371 of the information storage unit 360, and based on the received playback time and the extracted charge “5.0”, calculates a viewing/listening charge.
Expression: Viewing/listening charge=charge “5.0”*playback time

Next, the account settlement unit 356 reads the electronic money balance 372 from the secure area 371 of the information storage unit 360, subtracts the viewing/listening charge from the read electronic money balance 372, and overwrites the electronic money balance with the value obtained as a result of the subtraction.

Next, the account settlement unit 356 outputs an end signal, to the control unit 357, showing that account settlement of the electronic money finished normally.

(3) Control Unit 357

The control unit 357 has a time counter that measures elapsed time. The control unit 357 stores a acquisition time interval “15 minutes” that is an interval at which position information is to be obtained.

When device authentication by the authentication unit 353 and the authentication unit 603 of the electronic money charger 600 succeeds, the control unit 37 receives an inserted amount from the electronic money charger 600 via the input/output unit 351, and instructs account settlement. Next, the control unit 357 receives an end signal, from the account settlement unit 306, showing that account settlement of the electronic money ended normally.

When device authentication by the authentication unit 353 and the authentication unit 103 of the mobile telephone 150 succeeds, the control unit 357 repeats position judgment processing (described below) every acquisition time interval “15 minutes”.

Furthermore, the control unit 357 receives a content request signal from the mobile telephone 150 via the input/output unit 351. Upon receiving the content request signal from the mobile telephone 150, the control unit 357 performs content output processing described below. When content output starts, the control unit 357 performs output end check processing in parallel with the content output.

The following describes position judgment processing, content output processing, and output end check processing.

(Position Judgment Processing)

The control unit 357 transmits a position acquisition instruction to the mobile telephone 150. Upon receiving position information consisting of a latitude and a longitude from the mobile telephone 150, the control unit 357 overwrites the present position information 385 with the acquired position information.

Next, the control unit 357 reads the latitude “32′ 50″-35′ 15″” and longitude “130′ 00″-133′ 80″” that compose the viewing/listening area included in the playback information 383 stored in the information storage unit 360. Upon judging that that a current latitude 396 included in the current position information is included in the read latitude “32′ 50″-35′ 15″” and a current longitude 397 included in the current position information is included in the read longitude “130′ 00″-133′ 80″”, the control unit 357 sets the viewing/listening flag 384 to “1”. In other cases, the control unit 387 sets the viewing/listening flag 384 to “O”.

(Content Output Processing)

Upon receiving a content request signal from the mobile telephone 150 via the input/output unit 360, the control unit 357 reads the viewing/listening flag 384 from the secure area 371 of the information storage unit 360, and when the read viewing/listening flag is “0”, the control unit 357 outputs, to the mobile telephone 150 via the input/output unit 351, a area error signal showing that the memory card 350 and the mobile telephone 150 are outside the viewing/listening area of the content. The control unit 357 then stops the encrypted content output described below.

When the viewing/listening flag 384 is “1”, the control unit 357 reads the electronic money balance 372 from the information storage unit 360. When the read electronic money balance 372 is “0”, the electronic money stored in the memory card 350 is insufficient, and therefore the control unit 357 transmits, to the mobile telephone 150, a balance error showing that the content cannot be played, and stops output of the encrypted content 382.

When the read electronic money balance is not “0”, the control unit 357 calculates a time for which the content is viewable/listenable (hereinafter called a “viewable/listenable time”) with the electronic money based on the read electronic money balance 372 and the charge “5.0” included in the playback information 383. Specifically, the control unit 357 calculates the viewable/listenable time as follows:
Expression: viewable/listenable time=electronic money balance/charge

Next, the control unit 357 initializes the time counter to “0”, and starts counting time. The control unit 357 reads the content key 373 and the encrypted content 382, and outputs the read content key 373 to the mobile telephone 150 via the input/output unit 351. Next, the control unit 357 reads the blocks of the encrypted content 382 successively in order from the first block, and successively outputs the read blocks to the mobile telephone 150.

(Output End Check Processing)

Upon staring outputting the encrypted content 382, the control unit 357 determines which of “1” and “0” the viewing/listening flag 384 is, and when the viewing/listening flag 384 is judged to be “0”, stops outputting the encrypted content 382 and stops the time counter. The control unit 357 then outputs the value of the time counter to the account settlement unit 382 as the playback time, instructs the account settlement unit 382 to perform account settlement, and receives an end signal from the account settlement unit 356. Next, the control unit 357 outputs, to the mobile telephone 150 via the input/output unit 351, a area error signal showing that the memory card 350 and the mobile telephone 150 are outside the viewing/listening area.

When the viewing/listening flag 384 is “1”, the control unit 357 compares the calculated viewable/listenable time with the time counter. When the viewable/listenable time is judged to be equal to or less than the time counter, the control unit 357 stops outputting the encrypted content 382, stops the time counter, and outputs the value of the time counter as the playback time, and an account settlement instruction, to the account settlement unit 356. The control unit 357 then receives an end signal showing that account settlement of the electronic money has ended normally, from the account settlement unit 356. Next, the control unit 357 outputs, to the mobile telephone 150 via the input/output unit 351, a balance error signal showing that the electronic money in the memory card 350 is insufficient and the content cannot be played.

When it is judged that the viewable/listenable time is greater than the time counter, the control unit 357 then checks whether or not a playback end signal has been received from the mobile telephone 150, and if a playback end signal has not been received, the control unit 357 repeats the determination of which of “0” or “1” the viewing/listening flag 384 is and the comparison of the viewable/listenable time with the time counter, until a playback end signal is received from the mobile telephone 150.

Upon receiving a playback end signal from the mobile telephone 150, the control unit 357 stops outputting the encrypted content 382, stops the time counter, and outputs, to the account settlement unit 356, the value of the time counter as the playback time, and an account settlement instruction. The control unit 357 then receives an end signal from the account settlement unit 356.

2.4 Mobile Telephone 150

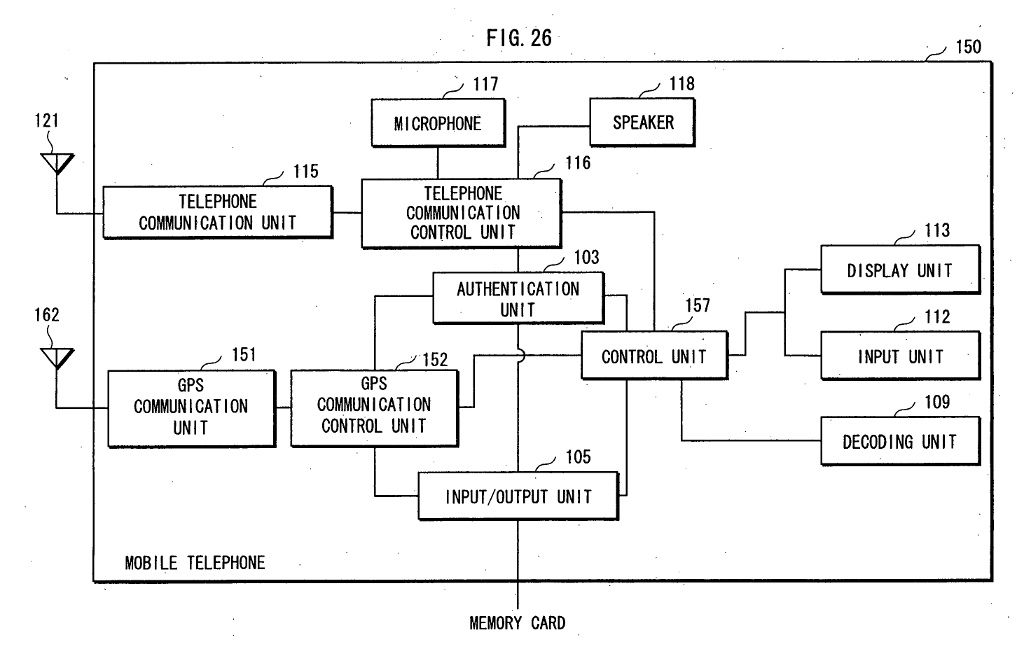

As shown in FIG. 26, the mobile telephone 150 is composed of a telephone communication unit 115, a telephone communication control unit 116, a microphone 117, a speaker 118, a GPS communication unit 151, a GPS communication control unit 152, an input/output unit 105, a control unit 157, an antenna 121, an antenna 162, an input unit 112, a display unit 113, a decoding unit 109, and an authentication unit 103.

The mobile telephone 150 is specifically a computer system composed of a microprocessor, a signal processor, a ROM, a RAM, and the like. The mobile telephone 150 achieves part of its functions by the microprocessor and the signal processor operating according to computer programs stored in the mobile telephone 150.

The structure and operations of the telephone communication unit 115, the telephone communication control unit 116, the microphone 117, the speaker 118, the input/output unit 105, the antenna 121, the input unit 112, the display unit 113, the decoding unit 109, and the authentication unit 103 are the same as the telephone communication unit 115, the telephone communication control unit 116, the microphone 117, the speaker 118, the input/output unit 105, the antenna 121, the input unit 112, the display unit 113, the decoding unit 109, and the authentication unit 103 of the mobile telephone 100 in the first embodiment, and therefore a description thereof is omitted.

(1) GPS Communication Control Unit 152, GPS Communication Unit 151, Antenna 162

Under the control of the control unit 157, the antenna 162 and the GPS communication unit 151 receive ranging signals transmitted on microwaves of a 1.6 GHz band from four GPS satellites 16, 17, . . . 18, and amplify and demodulate the received ranging signals. Under the control of the control unit 157, the GPS communication control unit 152 calculates position information (latitude and longitude) of where the mobile telephone 150 is, and outputs the calculated position information to the control unit 157.

(2) Control Unit 157

When device authentication by the authentication unit 103 and the authentication unit 353 of the memory card 350 succeeds, the control unit 157 receives a position acquisition instruction from the memory card 350 via the input/output unit 105.

Having received the position acquisition instruction, the control unit 157 instructs the GPS communication control unit 152 to acquire position information. Upon receiving position information composed of a longitude and latitude from the GPS communication control unit 152, the control unit 157 outputs the received position information to the memory card 350 via the input/output unit 105.

The control unit 157 also receives input of various operation instructions corresponding to button operations by the user. Upon receiving operation instruction information showing content playback, the control unit 157 transmits a content request to the memory card 350 via the input/output unit 105.

Next, the control unit 157 receives a area error signal, a balance error signal, or a content key and encrypted content, from the memory card 350.

When the area error signal is received, the control unit 157 generates a area error screen notifying that the current position is outside the content viewing/listening area, and has the area error screen displayed by the display unit 113.

When the balance error signal is received, the control unit 157 generates a balance error screen showing that the electronic money stored in the memory card 350 is insufficient, and has the generated balance error screen displayed on the display unit 113.

When the content key and the encrypted content are received, the control unit 157 outputs the received content key and encrypted content to the decoding unit 109, and instructs content playback.

During content playback, the control unit 157 may receive operation instruction information showing playback stop from the input unit 112, or may receive a area error signal or a balance error signal from the memory card 350.

When operation instruction information showing playback stop is received from the input unit 112, or when the content has been played to the end, the control unit 157 transmits a playback end signal to the memory card 350.

When a area error signal is received from the memory card 350, the control unit 157 generates a area error screen notifying that the current position is outside the content viewing/listening area, and has the generated area error screen displayed by the display unit 113.

When the balance error signal is received from the memory card 300, the control unit 157 generates a balance error screen showing that the electronic money stored in the memory card 350 is insufficient and the content cannot be played, and has the display unit 113 display the generated balance error screen.

2.5 Operations of the Area-Limited Content Usage System 2

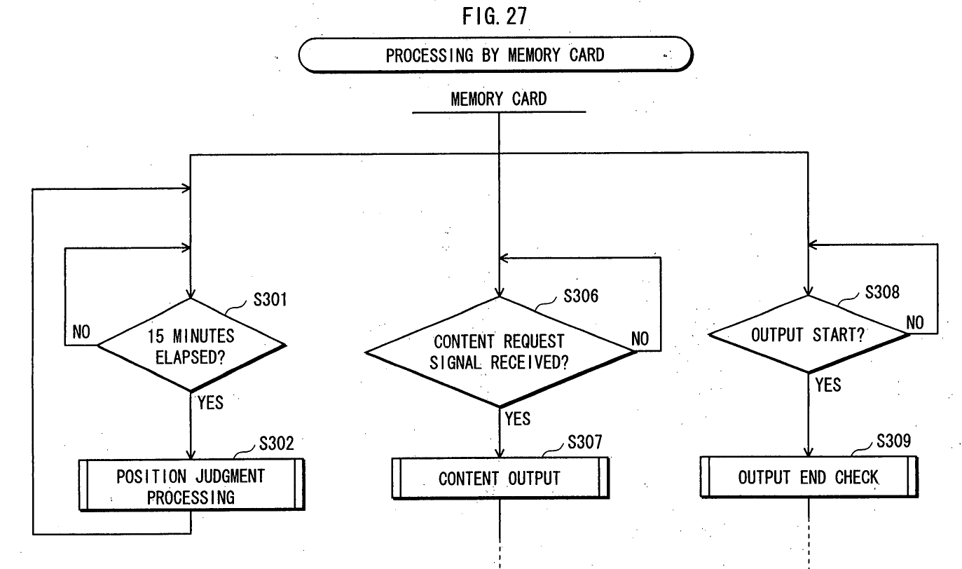

The following describes operations of each apparatus in content playback processing in the second embodiment, with use of the flowcharts shown in FIG. 27 to FIG. 31. Note that it is assumed that device authentication between the memory card 350 and the mobile telephone 150 succeeds before the following operations are performed.

(1) Processing by the Memory Card 350

The following describes processing performed by the memory card 350, with use of the flowchart shown in FIG. 27.

When device authentication with the mobile telephone 150 succeeds, every acquisition time interval of 15 minutes (step S301), the memory card 350 performs position judgment processing (step S302).

Upon receiving a content request signal from the mobile telephone 150 (step S306), the memory card 350 performs content output processing (step S307).

Upon starting output of the encrypted content 382 to the mobile telephone 150 (step S308), the memory card 300 also performs output end check processing in parallel (step S309).

(2) Position Judgment Processing

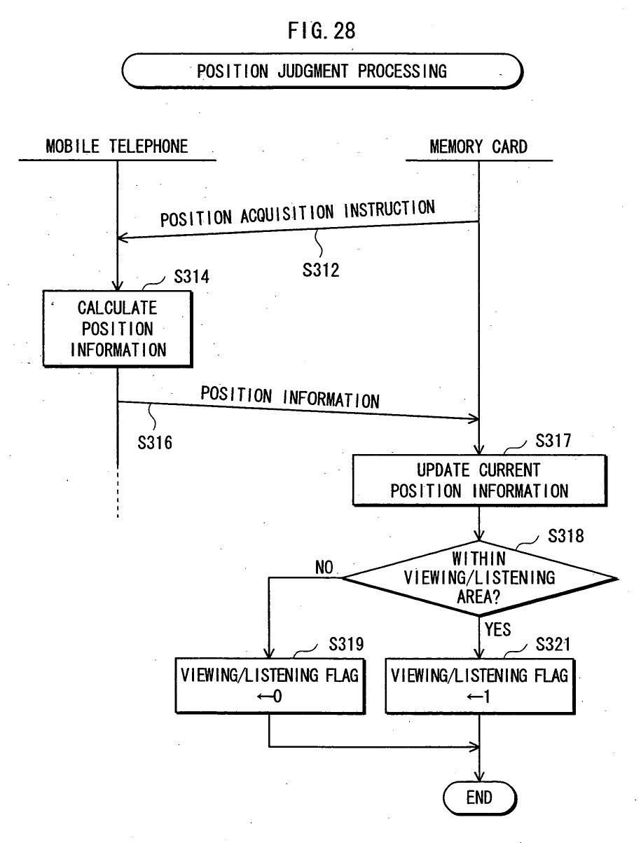

The following describes position judgment processing by the memory card 350 and the mobile telephone 150, with use of the flowchart shown in FIG. 28. Note that this processing is the details of step S302 of FIG. 27.

The memory card 350 outputs a position acquisition instruction to the mobile telephone 150 (step S312).

Upon receiving the position acquisition instruction from the memory card 350, the mobile telephone 150 receives ranging signals from the GPS satellites 16, 17, . . . 18, and calculates position information made up of a latitude and longitude, based on the received ranging signals (step S314). The mobile telephone 150 then transmits the calculated position information to the memory card 350 (step S316).

The memory card 350 receives position information from the mobile telephone 150, and updates the current position information 385 in accordance with the received position information (step S317). Next, the memory card 350 judges whether the position shown by the current latitude 396 and the current longitude 397 included in the updated current position information 285 is within the viewing/listening area (step S318). When the position shown by the current latitude 396 and the current longitude 397 is within the viewing/listening area (YES at step S318), the memory card 350 sets the viewing/listening flag 284 to “1” (step S321). When the position shown by the current latitude 396 and the current longitude 397 is outside the viewing/listening area (NO at step S318), the memory card 350 sets the viewing/listening flag 284 to “0” (step S319).

(3) Content Output

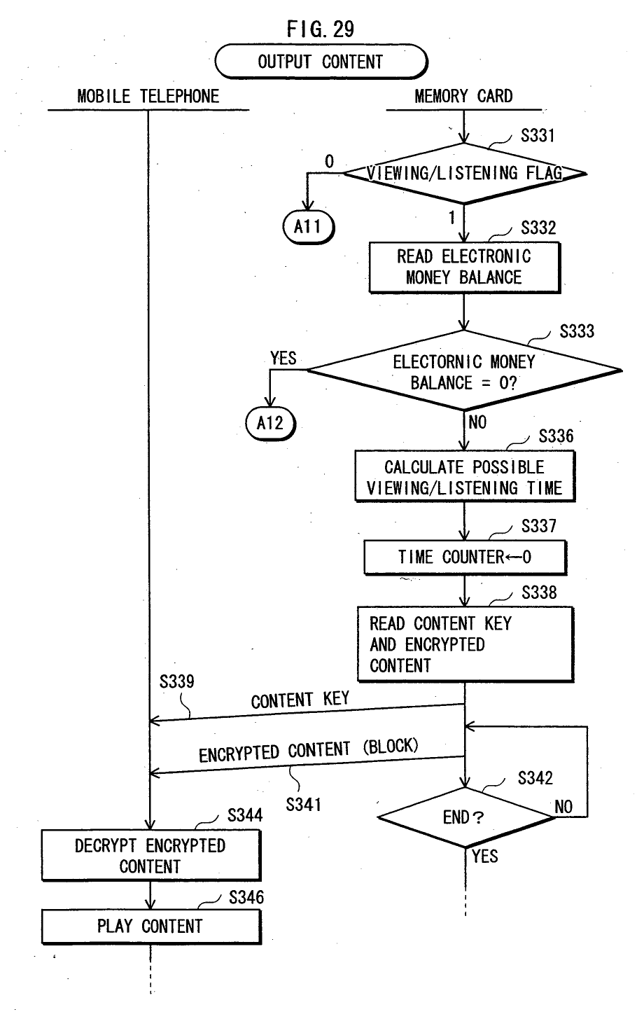

The following describes content output processing to the mobile telephone 150 by the memory card 350, with use of the flowchart shown in FIG. 29. Note that this processing is the details of step S307 of FIG. 27.

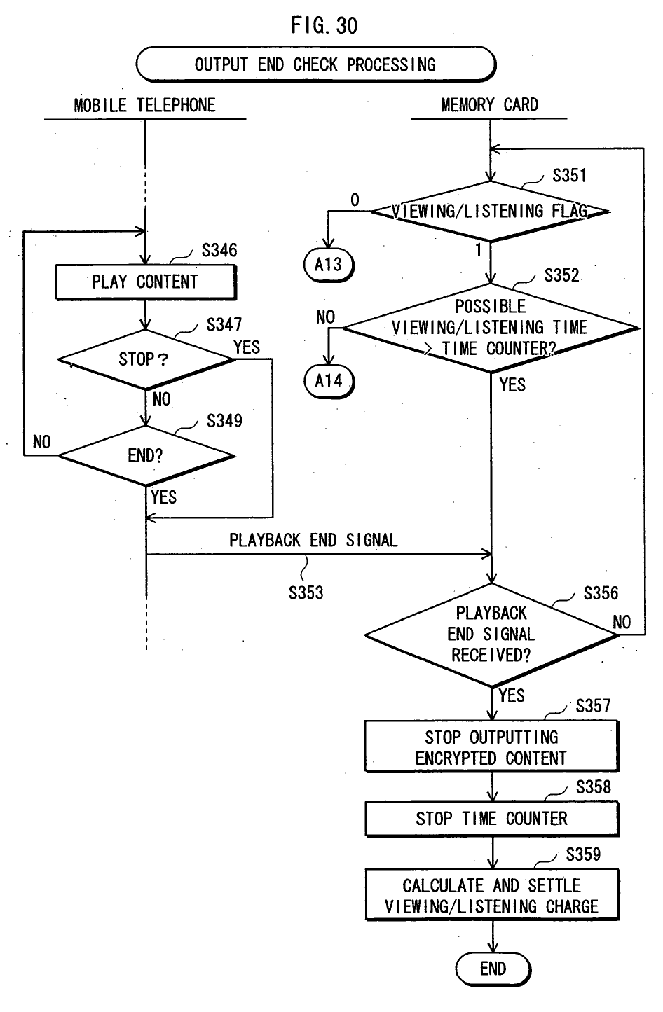

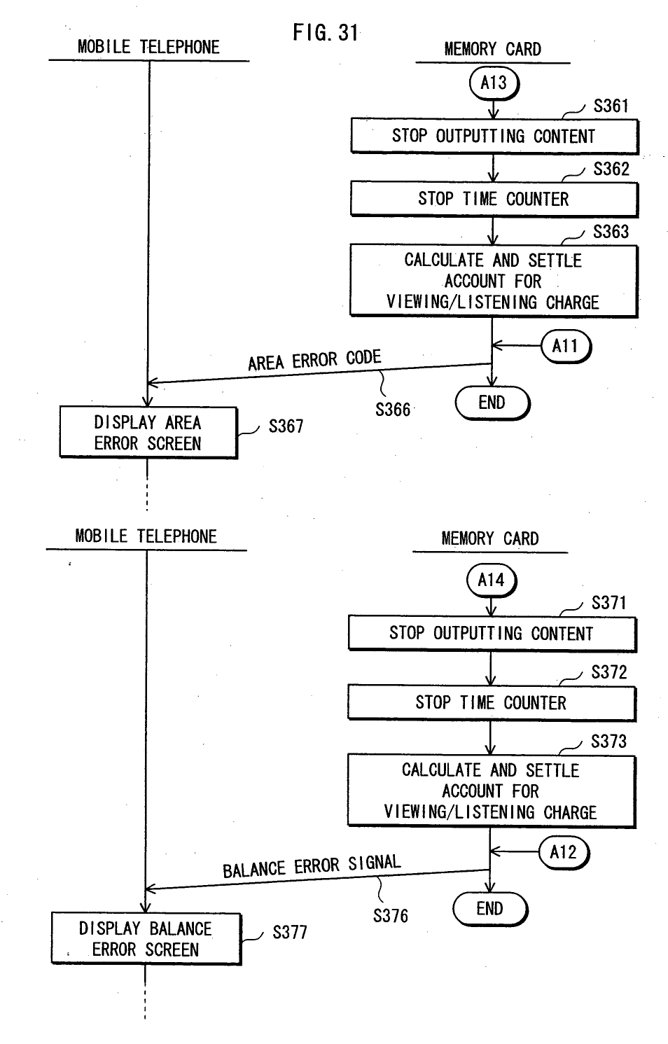

The memory card 350 determines which of “0” and “1” the viewing/listening flag 384 stored in the information storage unit 310 is (step S331). When the viewing/listening flag 384 is “0” (“0” at step S331), the memory card 350 moves the processing to step S336 which is output end check processing shown in FIGS. 30 to 31.

When the viewing/listening flag 384 is “1” (“1” at step S331), the memory card 350 reads the electronic money balance 372 from the information storage unit 310 (step S332). When the read money balance 372 is “0” (YES at step S333), the memory card 350 moves the processing to step S376 which is the output end check shown in FIGS. 30 to 31.

When the read electronic money balance 372 is not “0” (NO at step S333), the memory card 350 divides the read electronic money balance 372 by the amount “5.0” included in the playback information 383, to calculate a viewable/listenable time (step S336). The memory card 350 then initializes the time counter to “0”, and starts measuring the content playback time (step S337).

Next, the memory card 350 reads the content key 373 and the encrypted content 382 from the information storage unit 310 (step S338), outputs the read content key 373 to the mobile telephone 150 (step S339), and outputs the blocks of the encrypted content 382, starting from the first block, to the mobile telephone 150 (step S341). The memory card 350 then checks whether all the blocks have been output (step S342), and repeats steps S341 to S342 until all the blocks have been output.

The mobile telephone 150 receives the content key from the memory card 350, successively receives the blocks of the encrypted content, and using the received content key, decrypts the received encrypted content, to generate content (step S344). The mobile telephone 150 then expands the generated content, generates a screen and audio, and outputs the generated screen and audio to the display unit 113 and the speaker 118 (step S346).

(4) Output End Check

The following describes output end check processing with use of the flowchart shown in FIGS. 30 and 31. Note that this processing is the details of step S309 of FIG. 27.

Output of the encrypted content from the memory card 350 to the mobile telephone 150 starts, and the mobile telephone 150 decrypts and plays the received encrypted content (step S346).

Upon receiving a button operation showing playback stop from the user (YES at step S347), the mobile telephone 150 moves the processing to step S353. If a button operation showing playback stop is not received from the user (NO at step S347), the mobile telephone 150 judges whether the content has been played to the end (step S349), and if the content has been played to the end (YES at step S349), the mobile telephone 150 outputs a playback end signal to the memory card 350 (step S353).

If the content has not been played to the end (NO at step S349), the mobile telephone 150 moves the processing to step S346, and repeats the processing at steps S346 to step S349 until the content is played to the end, or until a button operation showing playback stop is received.

Upon starting output of the encrypted content 382 to the mobile telephone 150, the memory card 350 checks the viewing/listening flag 384 (step S351). When the viewing/listening flag 384 is “0” (“0” at step S351), the memory card 350 stops outputting content (step S361). The memory card 350 then stops the time counter (step S362), calculates a viewing/listening charge for viewing/listening to the content from the time counter and the charge “5.0” included in the playback information 383, and subtracts the calculated viewing/listening charge from the electronic money balance 372 (step S363). The memory card 350 then outputs a area error signal (step S366).

The mobile telephone 150 receives the area error signal from the memory card 350, generates a area error screen showing that the current position is outside the content viewing/listening area, and displays the generated area error screen (step S367).

When the viewing/listening flag 384 is “1” (“1” at step S351), the memory card 350 compares the viewable/listenable time with the time counter (step S352), and when the viewable/listenable time is equal to or less than the time counter (NO at step S352), stops outputting content (step S371), and stops the time counter (step S372). The memory card 350 then calculates a viewing/listening charge for viewing/listening to the content from the time counter and the charge “5.0” included in the playback information 383, and subtracts the calculated viewing/listening charge from the electronic money balance 372 (step S373). The memory card 350 then outputs a balance error signal (step S376).

The mobile telephone 150 receives the balance error signal from the memory card 350, generates a balance error screen notifying that the content cannot be played because the balance in the memory card 350 is insufficient, and displays the generated screen on the display unit 113 (step S377).

When the viewable/listenable time is greater than the time counter (YES at step S352), the memory card 350 then judges whether or not it has received a playback end signal from the mobile telephone 150 (step S356), and when a playback end signal has not been received (NO at step S356), returns to step S351, and repeats the processing at step S351 to step S356.

When a playback end signal is received from the mobile telephone (YES at step S356), the memory card 350 stops outputting the encrypted content 382 (step S357), and stops the time counter (step S358). Next, the memory card 350 calculates a viewing/listening charge for viewing/listening to the content from the time counter and the charge “5.0” included in the playback information 383, and subtracts the calculated viewing/listening charge from the electronic money balance 372 (step S359).

2.6 Summary

As has been described, the area-limited content usage system 2 of the second embodiment of the present invention uses GPS satellites to detect the position of the memory card 350, the mobile telephone 150 and the user, judges whether or not the detected-position in within the viewing/listening area, and allows content to be viewed/listened to if the position is within the viewing/listening area.

In this way, playback of the content can be restricted to the viewing/listening area. Furthermore, the judgment as to whether or not the content may be viewed/listened to is made based on longitude and latitude, and therefore the viewing/listening area can be set arbitrarily without being limited to a area bounded by a fence, a gate, or the like.

### 3. Third Embodiment

The following describes a location-limited content usage system as an embodiment of the present invention.

3.1 Location-Limited Content Usage System

As with the location-limited content usage system 1 of the first embodiment, the location-limited content usage system 3 is composed of a mobile telephone, a plurality of automated ticket barriers and an electronic money charger. The location-limited content usage system 3 also includes a plurality of express train ticket barriers.

The mobile telephone, the plurality of automated ticket barriers and the electronic money charger are the same as in the first embodiment, and therefore the following description focuses on the differences from the first embodiment.

In the present embodiment, the stations at which express trains stop have a platform specifically for express trains (hereinafter called an “express train platform”), and a ticket barrier for entering the express train platform (hereinafter called an “express train ticket barrier”) is provided between the express train platform and the automated ticket barriers.

After the user enters the station bypassing through an automated ticket barrier while carrying the mobile telephone having the memory card mounted therein, the user then passes through the express train ticket barrier to enter the express train platform.

Upon receiving a user operation to play content, the mobile telephone 100 reads the playback key, the encrypted content key and the encrypted content from the memory card, and uses these to play the content. If the user has already entered the express train platform, the memory card outputs all of the encrypted content. If the user has entered the station, but has not entered the express train platform, the memory card outputs only part of the encrypted content.

3.2 Memory Card 700

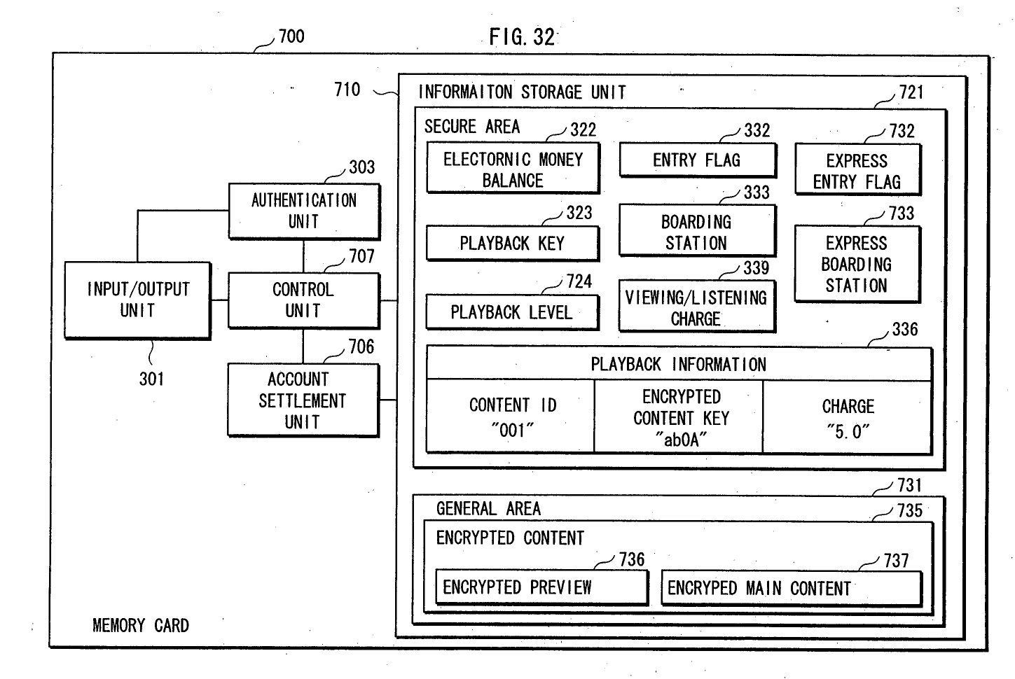

As shown in FIG. 32, a memory card 700 has a similar structure the memory card 300 of the first embodiment, and is composed of an input/output unit 301, an authentication unit 303, an account settlement unit 706, a control unit 707, and an information storage unit 710.

The input/output unit 301 and the authentication unit 303 are the same as described in the first embodiment, and therefore a description thereof is omitted here.

(1) Information Storage Unit 710

The information storage unit 710 is composed of a secure area 721 and a general area 731, and as shown in FIG. 32, stores various information. A description of the information already described in the first embodiment is omitted here, and a description is given only of a playback level 724, an express entry flag 732, an express boarding station 733, and encrypted content 735.

As shown in FIG. 32, the encrypted content 735 includes an encrypted preview 736 and encrypted movie content 737. Encrypted main content 738 has been generated by using a content key to encrypt main content composed of video and audio. The encrypted preview has been generated by using a content key to encrypt a preview of the main content. The preview is composed, for instance, of an advertisement for or a summary of the main content. For instance, if the main content is a movie, the preview may be a series of highlight scenes of the movie, and if the main content is music data, the preview may be the introduction of each song. In the description of the third embodiment hereinafter, “content” denotes the entire preview and main content.

The playback level 724 shows which portion of the content the mobile telephone 100 in which the memory card 700 is mounted can play, and is either “0”, “1” or “2”. A playback level “0” shows that the content cannot be played. The playback level “0” is stored in the memory card 700 when the content is initially sold or distributed. A playback level “1” shows that only the preview of the content can be played. A playback level “2” shows that the entire content can be played.

The express entry flag 732 is information showing whether or not entry processing (described later) between the memory card 700 and the express train ticket barrier has been performed. An express entry flag “1” shows that entry processing has been performed, and an express entry flag “0” shows that express entry processing has not been performed.

The express boarding station 733 is the name of the station at which the memory card 700 performed entry processing via the mobile telephone 100, in other words, the name of the station at which the user boarded an express train.

(2) Account Settlement Unit 716

The account settlement unit 706 performs similar processing to the account settlement unit 306 of the memory card 300 of the first embodiment under the control of the control unit 707. The account settlement unit 706 also receives an express charge and an account settlement instruction from the control unit 707.

Upon receiving the express charge and the account settlement instruction, the account settlement unit 706 reads the electronic money balance 322 from the secure area 721 of the information storage unit 710, and compares the read electronic money balance 322 with the received express charge. When the electronic money balance 322 is equal to or greater than the express charge, the account settlement unit 706 subtracts the express charge from the electronic money balance 322, and overwrites the electronic money balance 322 in the secure area 721 with the result of the subtraction. Next, the account settlement unit 706 outputs, to the control unit 707, an end signal showing that account settlement of the electronic money ended normally.

When the read electronic money balance 322 is less than the received express charge, the account settlement unit 706 generates an error signal showing that the electronic money is insufficient, and outputs the generated error signal to the control unit 707.

(3) Control Unit 707

The control unit 707 performs electronic money charge processing, and entry and exit processing with automated ticket barriers. However, the entry processing differs in that after receiving the playback key from the automated ticket barrier, the control unit 707 rewrites the playback level 724 to “1” showing that only the preview can be played. Furthermore, in the exit processing, after rewriting the entry flag to “0”, the control unit 707 rewrites the playback level 724 to “0” showing that playback is not possible.

Furthermore, when the user passes through the express train ticket barrier while carrying the mobile telephone 100 in which the memory card 700 is mounted to enter the express train platform, the control unit 707 performs entry processing with the express train ticket barrier via the mobile telephone 100. The entry processing between the memory card 700 and the express train ticket barrier is approximately the same as the entry processing between the memory card 300 and the automated ticket barrier described in the first embodiment (see step S131 to step S147 of FIG. 13), but with the omission of the transfer of the playback key. Note that the memory card 700 receives an express boarding station instead of a boarding station, rewrites the express entry flag 732 to “1” instead of the entry flag 332, and rewrites the playback level to “2” after rewriting the express entry flag 732.

Furthermore, when the user passes through the express train ticket barrier to exit the express train platform, the control unit 707 performs exit processing with the express train ticket barrier via the mobile telephone 100. The exit processing with the express train ticket barrier is approximately that same as the exit processing between the automatic ticket barrier and the control unit 307 of the memory card 300 (see step S191 to step S220 and step S227 to step S232 of FIG. 15 and FIG. 16), but with the omission of the processing for deleting the playback key and the initializing the viewing/listening charge. Note that the control unit 707 receives the express charge from the express train ticket barrier instead of the fare, deletes the express boarding station 733 instead of the boarding station 333, and changes the express entry flag 732 to “0” instead of the entry flag 332. In addition, after changing the express entry flag to 732 to “0”, the control unit 707 rewrites the playback level 724 to “1”.

Furthermore, the when the control unit 707 receives a content request signal and a current time from the mobile telephone 100 via the input/output unit 301 while the memory card 700 is mounted in the mobile telephone 100, the control unit 700 performs content playback processing in the same way as the first embodiment. The difference is that before outputting the playback key 323, the encrypted content key and the encrypted content 735 to the mobile telephone 700, the control unit 707 reads the playback level 724 from the information storage unit 710, and when the read playback level 724 is “2” showing the entire content is playable, the memory card 700 outputs the playback key 323, the encrypted content key and the encrypted content 735.

When the read playback level 724 is “1” showing that only the preview can be played, the control unit 707 outputs the playback key 323, the encrypted content key, and the encrypted preview 736 that is included in the encrypted content 735.

When the read playback level 724 is “0” showing that playback is not possible, the memory card 700 outputs an error signal showing that playback is not possible, to the mobile telephone 100.

3.3 Express Train Ticket Barrier

The express train ticket barrier is provided inside a station at the entrance to an express train platform, and manages entry and exit of users to and from the express train platform.

As with the automated ticket barrier, the express train ticket barrier is composed of a short distance communication unit, a short distance communication control unit, an antenna, a display unit, a speaker, an information storage unit, a fare searching unit, a control unit, a gate control unit, a gate, a sensor, and an authentication unit. The short distance communication unit, the short distance communication control unit, the antenna, the display unit, the speaker, the fare searching unit, the gate control unit, the gate, the sensor, and the authentication unit are the same as the short distance communication unit 401, the short distance communication control unit 402, the antenna 424, the display unit 413, the speaker 416, the fare searching unit 421, the gate control unit 422, the gate 423, the sensor 415, and the authentication unit 403 in the automated ticket barrier 400 in the first embodiment, and therefore a description thereof is omitted.

(1) Information Storage Unit

The information storage unit stores an express charge table. The express charge table has a similar structure to the fare table 441, and is a table of zones in which an express train is used, in correspondence with express fares.

Here, the fare searching unit extracts an express fare corresponding to a combination of an express boarding station and an express destination station from the express fare table instead of the fare table 441. Each express destination station is a station at which an express train ticket barrier is provided.

(2) Control Unit

The control unit stores a station name that is the station at which the express train ticket barrier is located.

The control unit regularly outputs a communication start signal via the short distance communication control unit, the short distance communication unit and the antenna, and detects the memory card 700 via the short distance communication control unit, the short distance communication unit, the antenna, and the mobile telephone. When the user passes through from outside the station to inside the station, in other words when a response signal is received from the memory card 700 via the antenna that points toward outside the station, the express train ticket barrier performs entry processing. When the user passes through from inside the station to outside the station, in other words when a response signal is received from the memory card 700 via the antenna that points toward inside the station, the express train ticket barrier performs exit processing.

Entry processing is approximately the same as entry processing by the control unit 407 of the automated ticket barrier 400, with the exception that reading and transmission of the playback key is omitted.

Exit processing is approximately the same as exit processing by the control unit 407 of the automated ticket barrier 400, with the exception that transmission of the key deletion instruction is omitted.

3.4 Conclusion and Effects

As has been described, the memory card 700 of the third embodiment rewrites the playback level 724 when performing communication with the automated ticket barrier and the express automated ticket barrier. When a content request signal is received from the mobile telephone, the memory card 700 outputs all or part of the encrypted content 735 to the mobile telephone in accordance with the playback level that it stores.

Consequently, when the user has entered the station, only the preview of the content is viewable/listenable, and with the user enters the express train platforms the main content also become viewable/listenable.

With this structure, usage of content in the station and the train can be encouraged, while dishonest playback of content outside the station can be prevented. Furthermore, a railway company that provides the described services can encourage users to use express trains.

Here, the playback level is increased in stages according to entry to the station and entry to the express train platform, and the portion of the content that can be played is increased in two stages. However, it is possible to further increase the playback level when the user uses a first class carriage such that there are three stages of the portion that can be played (for instance, special content showing the making of the movie that is the main content). This encourages usage of highly profitable services.

4. Modifications

Although the present invention has been described based on the above first to third embodiments, the present invention is not limited to these embodiments. The following cases are also included in the present invention.

In the first to third embodiments, charge processing is performed such that the viewing/listening charge for viewing/listening to the content is proportionate to the playback time. However, a uniform viewing/listening charge may be made for the viewing/listening to the content.

Specifically, in the first and third embodiments, when performing entry processing, account settlement is performed simultaneously with the playback key being received. In this case, a user who does not wish to view/listen to the content may make a setting in advance such that reception of the playback key is refused.

In the second embodiment, the memory card 350 further stores a charge flag. The charge flag has a value of “0” or “1”, with “0” showing that account settlement has not been performed for the charge and “1” showing that account settlement has been performed for the charge.

The memory card 350 receives a content request signal from the mobile telephone 150, and upon judging that the viewing/listening flag is “1”, then determines which of “0” and “1” the charge flag is, and if the charge flag is “1”, outputs the content key and the encrypted content to the mobile telephone 150.

If the charge flag is “0”, the charge is taken from the electronic money balance. When the account settlement for the charge has ended, the memory card 350 sets the charge flag to “1”, and memory card 350 outputs the content key and the encrypted content to the mobile telephone 150.

(2) In the first to third embodiments, a user purchases the memory cards 300, 350 and 700 having the content recorded thereon at the shop 30. However, the content may instead distributed free of charge by the content distribution manufacturer.

Providing the memory card free of charge encourages viewing/listening of the content by more people.

(3) In the first to third embodiments, charge processing is performed such that the viewing/listening charge for viewing/listening to the content is proportionate to the playback time. However, the viewing/listening charge may be proportionate to the data amount of the content viewed/listened to by the user.

Specifically, with content such as books and newspapers composed of text data or still images whose viewing/listening time differs depending on the user, a viewing/listening charge may be calculated, and account settlement processing performed therefor, proportionate to the number of characters of the text, the number of still images, or the total number of bits of data viewed/listened to.

(4) In the described embodiments and modifications, the memory card may store a plurality of encrypted content and playback information corresponding respectively to the encrypted content.

(5) In the first and third embodiments, in the exit processing, the memory card performs account settlement for a fare using electronic money. However, the memory card may store an electronic ticket such as a train ticket, a multiple trip ticket, or a commuter pass, and perform processing to check the electronic ticket instead performing account settlement for the fare.

Specifically, the memory card 300 stores the electronic ticket in the information storage unit. The electronic ticket includes an expiry date and usage zone information. When performing entry processing and exit processing, the memory card 300 transmits the expiry date and usage zone information to the automated ticket barrier 400 via the mobile telephone 100.

The automated ticket barrier 400 checks that the expiry date has not passed, or that the station at which the automated ticket barrier 400 itself is located is included in the usage zone. When the expiry date has passed, or when the station is not included in the usage zone, the automated ticket barrier 400 closes the gate.

Furthermore, the memory card may store bonus points, a coupon, or a discount ticket, and perform account settlement using the points or the like instead of the electronic money or electronic ticket, or in combination with the electronic money.

(6) In the first embodiment, the usage system is described as being used only in a railway station and a train. However, instead of a railway station and a train, the system may be used at an airport and in a plane, or in a bus, or another means of transportation.

Furthermore, the system may be a system that enables content to be used from the entrance to a motor expressway until exiting the motor expressway through an exit.

(7) In the first and third embodiments, instead of a means of transportation, the system may be used for a facility such as concert hall, a theater, a cinema, an amusement park or the like. In this case, the memory card 300 stores in advance content and an electronic ticket for entering the facility. The user passes through the automated ticket barrier while carrying the memory card 300 mounted in the mobile telephone 100.

The automated ticket barrier 400 checks the performance name, performance date, ticket number and the like of the electronic ticket stored in the memory card 300, and transmits the playback key.

The automated ticket barrier 400 instructs the memory card 300 to delete the playback key.

Furthermore, instead of an electronic ticket, the memory card may store a passage permit that allows passage into a specific building such as a school or office, a specific site, or a specific room. In such a case, the system includes an entrance/exit management apparatus that has similar functions to the automated ticket barrier. The entrance/exit management apparatus performs device authentication and transfer of the playback key with memory card in the same way as the automated ticket barrier, but it is not mandatory for the entrance/exit management apparatus to have a gate.

(8) In the modification (7) above, the seller of the electronic ticket may sell (or distribute as a bonus) content together with the electronic ticket, and may provide different content regarding the same performance depending on the performance date.

Selling or distributing different content depending on the performance date can encourage users to use the facility repeatedly.

(9) In the first and third embodiments and the modifications, the memory card stores encrypted content and the encrypted content key, and in entry processing, receives the playback key from the automated ticket barrier 400. However, the content itself may instead be transferred from the automated ticket barrier 400 to the memory card 300.

In such a case, the memory card 300 receives the content from the automated ticket barrier 400 at the time of entry, and in accordance with an instruction from the automated ticket barrier 400, deletes the content at the time of exit.

In particular, in the third embodiment, the memory card 700 may receive the preview instead of the playback key from the automated ticket barrier, and receive the main content from the express train ticket barrier.

(10) In the first embodiment, the memory card 300 already stores encrypted content or content when entering the station. However, the memory card 300 may acquire content after entering the station.

More specifically, a vending machine that sells the encrypted content and encrypted content key is provided in the station. The vending machine sores encrypted content, encrypt content keys, and selling price information in correspondence.

The user mounts the memory card 300 in the vending machine.

The vending machine reads the entry flag from the memory card 300, and if the entry flag is “0”, which means that entry processing has not been performed between the memory card 300 and the automated ticket barrier, transmits an error signal showing that the content cannot be acquired.

If the entry flag is “1”, the vending machine outputs the selling price, information to the memory card 300, and requests account settlement.

The memory card 300 subtracts the selling price information from the electronic money balance 322, and notifies the vending machine that account settlement has ended.

Upon receiving the notification of the end of account settlement, the vending machine writes the encrypted content and the encrypted content key to the memory card 300.

Similarly in the third embodiment, the content may be acquired after entering the station, and the express-specific content may be acquired after entering the express train platform.

(11) In the modification (10) above, the ticket vending machine, may receive payment in cash instead of the account settlement using electronic money.

(12) In the second embodiment, the memory card 350 acquires position information composed of the latitude and longitude calculated by the GPS communication control unit of the mobile telephone 150. However, the memory card 350 may receive ranging signals from the GPS satellites 16, 17 . . . 18 via the antenna 162 and the communication unit 151 of the mobile telephone 100, and calculate the latitude and longitude using the received ranging signals.

(13) In the second embodiment, the memory card 350 judges whether the mobile telephone 150 and the memory card 350 are in the viewing/listening area according to the latitude and longitude calculated by the mobile telephone 150. However, the memory card 350 may instead use a base station to determine the position of the mobile telephone 150 and the memory card 350.

In this case, the memory card stores a base station ID included in the playback information 383 instead of a viewing/listening area.

The mobile telephone 150 regularly compares the reception strength of radio waves transmitted from surrounding base stations, selects the base station transmitting the radio wave with the strongest reception intensity, and performs transmission/reception of various information including audio via the selected base station. The mobile telephone 150 stores the base station ID that is unique to the selected base station. When the mobile telephone 150 re-selects a base station, the mobile telephone 150 outputs the base station ID of the newly selected base station to the memory card 350.

Upon receiving the base station ID from the mobile telephone 100, the memory card 300 reads the base station information from the stored playback information, compares the read base station information with the received base station ID, and if the two match, sets the viewing/listening flag to “1”. If the two do not match, the memory cad 300 sets the viewing/listening flag to “0”.

(14) In the second embodiment, the memory card 350 stores a content viewing/listening area, and compares the viewing/listening area with a current position acquired from the mobile telephone 150 to judge whether or not the memory card 350 and the mobile telephone 150 are in a viewable/listenable range. However, the content management apparatus 250 may make this judgment.

In this case, the memory card 350 acquires the position information from the mobile telephone 150, reads the content ID “001” included in the playback information, and transmits the read content ID “001” and the acquired position information to the content management apparatus 250.

The content management apparatus 250 receives the content ID “001” and the position information from the memory card 350 via the Internet 20, the mobile telephone network 10 and the mobile telephone 150. The content management apparatus 250 selects the viewing/listening area information 272 that includes the received content ID “001”, and extracts the viewing/listening area from the selected viewing/listening area information 272.

The content management apparatus 250 determines whether or not the latitude and longitude included in the received position information are within latitude “32′ 50″ to 35′ 15″” and the longitude “130′ 00″ to 133′ 80″” included in the extracted viewing/listening area.

In the case of the latitude in the received position information being included in the latitude “32′ 50″ to 35′ 15″” and the longitude in the received position information being included in the longitude “130′ 00″ to 133′ 80″”, the content management apparatus 250 transmits a viewing/listening permission signal to the memory card 350. In other cases the content management apparatus 250 transmits a viewing/listening prohibition signal.

The memory card 350 receives the viewing/listening permission signal or the viewing/listening prohibition signal from the content management apparatus 250. When the viewing/listening permission signal is received, the memory card 350 sets the viewing/listening flag to “1”, and when the viewing/listening prohibition signal is received, the memory card 350 sets the viewing/listening flag to “0”.

(15) In the above modification (14), a further possible structure is one in which the memory card 350 does not store the content key, and the content management apparatus 250 transmits the content key instead of the viewing/listening permission signal, and transmits the content key deletion instruction instead of the viewing/listening prohibition signal.

Furthermore, the memory card 350 may store an encrypted content key instead of the content key, and the content management apparatus 250 may transmit a playback key for decrypting the encrypted content key, instead of the viewing/listening permission signal, and transmit a playback key selection instruction instead of the viewing/listening prohibition signal.

(16) In the above modifications (14) and (15), the memory card 350 may receive the content from the content management apparatus 250.

More specifically, when the position information is acquired from the mobile telephone 150, the memory card 350 transmits the acquired position information to the content management apparatus 250 via the mobile telephone 150, the mobile telephone network 10 and the Internet 20.

The content playback apparatus 250 selects, from the viewing/listening area table 271, the viewing/listening area information that includes the viewing/listening area shown by the received position information, and transmits the content corresponding to the content ID included in the selected viewing/listening information to the memory card 350.

(17) In the second embodiment and the above modifications (14) to (16), the viewing/listening area is specified by a range of longitudes and latitudes. However, the viewing/listening area may be more specifically a particular prefecture or municipality.

Specifically, the content management apparatus 250 may store map information, and the viewing/listening range of each content may be expressed as a prefecture or a municipality.

The content management apparatus 250 selects a viewing/listening area based on the content ID received from the memory card 350, and based on the stored map information and viewing/listening area, determines whether or not the current position is included viewing/listening area.

(18) In the third embodiment, an example is given of an express train ticket barrier being located in the station, but the third embodiment is not limited to this structure.

For instance, a device for checking boarding of users onto a train may be provided at the entrance to a carriage of an express train, or at the seats of the express train, and when or after a user boards the express train, the device and the memory card communicate, and when the boarding check ends normally, the playback level 724 is rewritten.

As a further example, the conductor of the train may carry a portable ticket inspection terminal, and when the conductor inspects the ticket of the user in the train, the portable ticket inspection terminal rewrites the playback level 724 to “2”.

Alternatively, a vending machine that sells electronic express tickets may be provided in the station, and the playback level 724 may be rewritten to “2” when the user purchases an electronic express ticket from this vending machine.

(19) Furthermore, in the third embodiment, the playback level is changed from “2” to “1” when the user exits the express train platform, and from “1” to “0” when the user exits the station. However, an possible alternative structure is to make no change to the playback level when the user exits the express train platform, and to change the playback level from “2” to “0” when the user exits the station.

Furthermore, before exiting the station, when the memory card 700 already stores an electronic express ticket, the automated ticket barrier may compare the effective date of the electronic express ticket with the current date, and when the two match, transmit the playback key and express ticket check notification showing that the express ticket has been checked, to the memory card 700. Upon receiving the express ticket check notification, the memory card 700 rewrites the playback level 724 from “0” to “2”.

(29) In the third embodiment, the content is structured from a preview and main content, the playback level “1” shows that only the preview is playable, and the playback level “2” shows that the entire content is viewable/listenable, however, the content may be made partially playable depending on the playback level.

For instance, when the playback level is “1”, a portion of the content that is the first ten minutes from the start of the content may be playable. More specifically, a restriction address may be recorded in the playback information of the memory card 700. The restricted address is an address showing a position that stores the block or blocks corresponding to the portion played ten minutes after the start, when the encrypted content is decrypted and played in order from the start.

When the playback level 724 is “1”, the control unit 707 of the memory card 700 outputs, to the mobile telephone, the encrypted content from the start up to the block stored at the restricted address.

(21) Furthermore, the playback time may be restricted according to the playback level. In such a case, the memory card 700 stores a restriction time “10 minutes” as part of the playback information 336.

When a content request signal is received from the mobile telephone 100, if the playback level 724 is “1”, the control unit 707 starts measuring time together with the commencement of the output of the content, and when the elapsed time reaches the restriction time “10 minutes”, output of the encrypted content is stopped.

In the third embodiment and the modifications, the encrypted preview and the encrypted main content can be decrypted using the same playback key and encrypted content key. However, a separate set of an encrypted content key and playback key may exist for each of the encrypted preview and the encrypted main content.

In this case, the memory card 700 stores a first encrypted content key corresponding to the to the encrypted preview, and a second encrypted content key corresponding to the encrypted main content.

The automated ticket barrier transmits a first playback key for decrypting the first encrypted content key to the memory card 700 when performing entry processing.

The express train ticket barrier transmits a second playback key for decrypting the second encrypted content key to the memory card 700 when performing entry processing.

(23) Furthermore, in the third embodiment, the content is not limited to being composed of a preview and main content. As one example, the content may instead be low picture quality content and high picture quality content, and the memory card 700 may store encrypted low quality content and encrypted high quality content. If the playback level 724 is “1”, the memory card 700 outputs the encrypted low picture quality content and the encrypted content key to the mobile telephone, and if the playback level 724 is “2”, the memory card 700 outputs the encrypted high quality content, the playback key and the encrypted content key to the mobile telephone, instead of outputting the encrypted low quality content.

Furthermore, a plurality of content that are unrelated to each other, and playback levels corresponding respectively to the contents may be stored in the memory card 700. The playback levels corresponding to the content may be compared with the playback level 724, and only the content whose playback level matches the playback level 724 are output.

(24) In the described first to third embodiments, when playback of the content is recommenced after having been stopped, the playback may start from the position in the content at which playback was stopped.

In this case, when playback is stopped, the control unit of the memory card writes an interruption address to the general area of the information storage unit. The interruption address is an address in the general area 731 showing the start of the block, among the blocks of the encrypted content, that was being output to the mobile telephone when playback was stopped. Alternatively, the address may be a relative address based on the start of the encrypted content.

When a content request signal is received from the mobile telephone, the control unit searches the general area for an interruption address, and if an interruption address exists, starts output of the encrypted content to the mobile telephone starting from the block shown by the interruption address. When output of the last block of the encrypted content ends the interruption address is deleted from the general area.

Furthermore, in the first and third embodiment, the memory card may transmit the interruption address to the automated ticket barrier, instead of storing the interruption address itself. Alternatively, a management apparatus that manages the automated ticket barriers may store the interruption address.

In this case, when performing exit processing, the memory card transmits, to the automated ticket barrier, the content ID and a card ID that is unique to the memory card.

Each automated ticket barrier is connected to a management apparatus via a network. The automated ticket barrier transmits a card ID, content ID and interruption address received from the memory card to the management address.

The management apparatus receives the card ID, the content ID and the interruption address, and stores the received card ID, content ID and interruption address.

When performing entry processing, the memory card transmits its own card ID to the automated ticket barrier, and the automated ticket barrier inquires to the management apparatus as to whether the management apparatus stores the received card ID. If the management apparatus stores the card ID, the automated ticket barrier acquires the content ID and interruption address corresponding to the received card ID, and transmits these to the memory card.

(25) In the first and third embodiments, the description is given of a case in which the user leaves the platform after performing an operation to stop playback or after playback of the entire content has ended. However, when the user passes through the automated ticket barrier to exit, the memory card may perform exit processing to forcedly end the playback of the content by the mobile telephone.

Similarly, in the above modification (24), when the user passes through the automated ticket barrier to leave the platform while the content is being played, the playback of the content may be forcedly stopped, and the interruption address acquired.

(26) In the first embodiment, the general area 331 of the memory card 300 may store encrypted advertisement content in addition to the encrypted content, and discount the content viewing/listening charge and/or the train fare according to how long the mobile telephone played the advertisement.

Here, the encrypted advertisement content has been generated by encrypting advertisement content that includes an advertisement for some kind of product, store or company. The key used for the encryption may be the same as the content key used to generate the encrypted content, or may be a separate advertisement content key, but the following description describes a case of the same key being used.

Specifically, upon receiving operation instruction information instructing playback of content from the input unit 112, the control unit 107 of the mobile telephone 100 generates a selection screen for having the user select whether or play the advertisement or whether to play the content, and has the screen displayed by the display unit 113. In accordance with the user's selection, the control unit 107 requests either the encrypted advertisement content or the encrypted content from the memory card 300.

When encrypted content is requested, the memory card, as already described, outputs the encrypted content 335 to the mobile telephone 100, and calculates the viewing/listening charge when playback ends.

When encrypted content is requested, the control unit 307 of the memory card 300 starts measuring the playback time of the advertisement content simultaneously with outputting the encrypted advertisement content, the encrypted content key, and the playback key. When playback of the advertisement content ends or is stopped, the control unit 307 stops measuring the advertisement playback time, and calculates an discount amount. One example of how this discount amount may be calculated is to store in advance an amount “3 yen” that is a discount per one minute of viewing/listening, and calculate the product of the advertisement playback time and “3 yen” as the discount amount.

When exit processing is performed, the account settlement unit 306 receives the fare and an instruction to perform account settlement from the control unit 307, reads the viewing/listening charge 339 and the discount amount from the information storage unit 310, and calculates a payment amount by subtracting the discount amount from the total of the received fare and the read viewing/listening amount 339.

In the first embodiment, the subsequent processing is performed using the payment amount instead of the total of the fare and the read viewing/listening charge 339.

Similarly, in the second and third embodiments, the viewing/listening charge may be discounted in accordance with the playback time of advertisement content.

Furthermore, instead of playback time, the number of times of playback (hereinafter called “playback count”) of the advertisement content may be counted, and the viewing/listening charge discounted in accordance with the playback count. If the advertisement content is still images, text data or the like, the discount amount may be calculated in accordance with the viewed number of characters, the viewed number of pages or the viewed data amount.

(27) In the first embodiment, when the user attempts to play the content outside the station, in other words, when a content request signal is received when the entry flag 332 is “0”, the memory card 300 outputs, to the mobile telephone 100, an error signal showing that entry processing has not been performed and that the playback key has not be acquired, and the mobile telephone 100 displays a screen showing that the content cannot be played.

However, the operations of the memory card 300 and the mobile telephone 100 when the user attempts to play the content outside the station are not limited to those described above. Instead, the mobile telephone 100 may display an information screen providing information about a railway company or railway line where playback is possible.

For instance, the playback information stored in the secure area 321 of the memory card 300 may include a content title, and a railway company name and a railway company unique identifier of a railway company that collaborates with the content distribution manufacturer. In the case of a plurality of encrypted content being stored in the general area 331, the playback information corresponding to each encrypted content may have a different railway company name and identifier. Furthermore, the memory card 300 may store in the general area information screen data for generating an information screen described later.

In the entry processing with the automated ticket barrier, the control unit 307 of the memory card 300 acquires an identifier showing the railway company that operates the railway that includes the automated ticket barrier, from the automated ticket barrier together with the playback key, and when performing exit processing, the control unit 307 deletes the received identifier together with the playback key.

The mobile telephone 100 reads the title and content ID from each playback information in the memory card 300, generates and has displayed a screen showing a list of the read titles, and has the user select the title of the content that he/she wishes to view/listen to. Next, the control unit 307 outputs the content ID corresponding to the selected title and a content request signal to the memory card 300.

In the case of a playback key existing in the information storage unit 301 and the identifier included in the playback information corresponding to the content ID received from the mobile telephone 100 matching the identifier received from the automated ticket barrier, the control unit 307 of the memory card 300 outputs the encrypted content corresponding to the received content ID to the mobile telephone 100.

In other cases, the control unit 307 outputs to the mobile telephone 100 an error signal showing that the content cannot be played, the name “XYZ Railways” of the railway company included in the playback information corresponding to the received content ID, and the stored information screen data.

Upon receiving the error signal, the railway company name, and the information screen data, using the received name and information screen data, the mobile telephone 100 generates and has displayed by the display unit 113 an information screen displaying a message such as “The content you have selected can be viewed in stations and trains of XYZ railways.”

The third embodiment may have a similar structure. In the second embodiment, a screen may be displayed that informs the user of the area in which the content is playable. In particular, in the third embodiment, a more detailed screen may be displayed that informs the user that only the preview can be viewed/listened on ordinary lines and that the main content can be viewed/listened to on express lines.

(28) In the first and third embodiments, the memory card is not limited to receiving a playback key from the automated ticket barrier, and outputting the received playback key, encrypted content key and encrypted content to the mobile telephone.

For instance, the memory card itself may store in advance the playback key, and when a content request signal is received from the mobile telephone, if the entry flag is “1”, the memory card may output the playback key, the encrypted content key and the encrypted content to the mobile telephone.

Furthermore, it is not necessary for a playback key to exist. The memory card may store a content key instead of the encrypted content key, and outputs the content key and the encrypted content to the mobile telephone.

(29) In the first to third embodiments and the modifications, the memory card may include a function of decrypting encrypted content.

(30) In the first and third embodiments, when the memory card and the automated ticket barrier perform exit processing, the automated ticket barrier transmits a key deletion instruction to the automated ticket barrier, and subsequently transmits an account settlement signal, thus ending the exit processing (steps S223 to S229 of FIG. 16). Here, it is assumed that the memory card deletes the playback key normally in accordance with the automated ticket barrier. However, after transmitting the key deletion instruction, the automated ticket barrier may check that the playback key has actually been deleted.

For instance, after receiving the key deletion instruction and deleting the playback key, the memory card may transmit deletion completion notification, to the automated ticket barrier, showing that deletion of the playback key has been completed normally.

After transmitting the key deletion instruction, the automated ticket barrier measures time, and when the deletion completion notification is received within a predetermined time, transmits the account settlement completion signal. If the gate is closed when the account settlement completion signal is transmitted, the automated ticket barrier opens the gate.

When deletion completion notification is not received within the predetermined time from transmitting the key deletion instruction, the automated ticket barrier closes the gate.

By having the gate apparatus check in this way that key deletion has been completed, dishonest use of content after the user has left the station can be prevented.

Furthermore, in the third embodiment, in the exit processing between the express train ticket barrier, the memory card 700 may transmit a signal, to the express train ticket barrier, showing that it has rewritten the playback level 724 from “2” to “1” normally, and the express train ticket barrier may open the gate when the signal is received, and close the gate when the signal is not received.

(31) The present invention is also a playback control apparatus for permitting and prohibiting playback of content inside and outside an area accessible through a gate, the playback control apparatus including: an acquisition unit operable to acquire, from a gate apparatus located at the gate, passage information showing passage through the gate; a judgment unit operable to judge, based on the passage information, whether or not playback of the content is permitted; and a playback control unit operable to permit or prohibit playback of the content based on the judgment. The following describes the present modification more specifically.

The memory card stores in advance a permission flag showing whether or not to permit the mobile telephone to play the content, and an encrypted content key and a content key. The permission flag being “1” shows permission, and the permission flag being “0” shows prohibition. Furthermore, the memory card includes a communication counter that counts the number of times that the memory card and the automated ticket barrier perform communication. The communication counter is pre-set to “0” when the memory card is sold (distributed).

The automated ticket barrier is, for instance, located at the entrance of a museum or the like. When a user enters the museum while carrying the mobile telephone having the memory card mounted therein, the automated ticket barrier communicates with the mobile telephone.

The communication between the memory card and the mobile telephone is extremely simple processing that is the same when entering and exiting. The automated ticket barrier regularly issues a communication start signal, and the memory card receives the communication start signal via the mobile telephone. Upon receiving the communication start signal, the memory card transmits a response signal to the automated ticket barrier, and subsequently performs device authentication with the automated ticket barrier. When device authentication is successful, the automated ticket barrier transmits communication completion notification to the memory card. The memory card receives the completion notification, and adds “one” to the communication counter. Here, if the value of the communication counter is an even number, the memory card sets the permission flag to “0”, and if the value of the communication counter is an odd number, the memory card sets the value of the permission flag to “0”.

In this way, the communication can be simplified so that the memory card can determine whether playback of the content is permitted or prohibited by counting the number of times it passes through the automated ticket barrier.

(32) In the first to third embodiments and the modifications, the memory card is used in a mounted state in the mobile telephone. However, instead of the memory card, an IC chip having the same functions as the memory card may be included in the mobile telephone.

It is possible for the IC chip to include only part of the functions corresponding to the authentication unit, the account settlement unit and the control unit 107 of the embodiments, and the IC chip may perform entry and exit processing with the automated ticket barrier, account settlement processing using the electronic money, and judgment of whether or not the content is permitted to be viewed/listened to. In this case, the encrypted content and the encrypted content key may be recorded in an external recording medium such as a memory card.

Furthermore, although the memory card is described as performing communication with the automated ticket barrier via the mobile telephone, the memory card may be a non-contact IC card the performs wireless communication with the automated ticket barrier.

(33) In the first and second embodiments, the medium used to play the content is the mobile telephone. However, the medium used to play the content may instead be a PDA (personal digital assistant), a portable game device, or the like.

(34) The present invention may be methods shown by the above. Furthermore, the methods may be a computer program realized by a computer, and may be a digital signal of the computer program.

Furthermore, the present invention may be a computer-readable recording medium such as a flexible disk, a hard disk, a CD-ROM, an MO, a DVD, a DVD-ROM, a DVD-RAM, a BD (Blu-ray Disc) or a semiconductor memory, that stores the computer program or the digital signal. Furthermore, the present invention may be the computer program or the digital signal recorded on any of the aforementioned recording media.

Furthermore, the present invention may be the computer program or the digital signal transmitted on a electric communication network, a wireless or wired communication network, a network of which the Internet is representative, or a data broadcast.

Furthermore, the present invention may be a computer system that includes a microprocessor and a memory, the memory storing the computer program, and the microprocessor operating according to the computer program.

Furthermore, by transferring the program or the digital signal to the recording medium, or by transferring the program or the digital signal via a network or the like, the program or the digital signal may be executed by another independent computer system.

(35) All or part of the compositional elements of each apparatus may be composed of one system LSI (Large Scale Integrated circuit). The system LSI is a super-multifunctional LSI on which a plurality of compositional units are manufactured integrated on one chip, and is specifically a computer system that includes a microprocessor, a ROM, a RAM, or the like. Computer programs are stored in the RAM. The system LSI achieves its functions by the microprocessor operating according to the computer programs.

(36) The present invention may be any combination of the above-described embodiment and modifications.

### INDUSTRIAL APPLICABILITY

The present invention can be used managerially, in other words, repeatedly and continuously, in industries that generate various contents made up of video, audio and text data, and the contents are sold, lent, and transferred via recording media or networks. Furthermore, the present invention can be used be manufactured and sold managerially, in other words, repeatedly and continuously in an industry that manufactures and sells electronic devices including a computer system that processes the contents. Furthermore, the present invention can be used be manufactured and sold managerially, in other words, repeatedly and continuously in an industry that provides transport such as trains, buses, and airplanes, and an industry that provides entertainment such as theatrical performances and movies.

1. A playback control apparatus for permitting and prohibiting playback of content inside and outside an area having a gate, the playback control apparatus comprising:
an acquisition unit operable to acquire, from a gate apparatus located at the gate, either one of entry information showing entry into the area through the gate and exit information showing exit from the area through the gate; and
a playback control unit operable to permit playback of at least part of the content according to the entry information when the entry information is acquired, and to prohibit playback of the content according to the exit information when the exit information is acquired.

2. The playback control apparatus of claim 1, wherein
the acquisition unit acquires, as the entry information, key information for decrypting encrypted content generated by encrypting the content, and
the playback control unit stores the acquired key information, and permits playback of at least part of the content by outputting the stored key information.

3. The playback control apparatus of claim 2, wherein
the acquisition unit acquires, as the exit information, a deletion instruction instructing deletion of the key information, and
the playback control unit prohibits playback of the content by deleting the stored key information in accordance with the acquired deletion instruction.

4. The playback control apparatus of claim 2, wherein
the content is composed of a first content portion and a second content portion,
the playback control unit, when the key information is acquired, permits playback of, among the content, the first content portion,
the playback control apparatus further comprises: an information acquisition unit operable to acquire service information relating to a service provided inside the area, and
the playback control unit further permits playback of the second content portion when the service information is acquired.

5. The playback control apparatus of claim 2, wherein
the playback control unit, when the key information is acquired, permits playback of at least part of the content only within a predetermined time limit,
the playback control apparatus further comprises: an information acquisition unit operable to acquire service information relating to a service provided inside the area, and
the playback control unit further, when the service information is acquired, releases the time limit relating to playback of the content.

6. The playback control apparatus of claim 2, further comprising:
an electronic money storage unit operable to store electronic money that is used as currency; and
an account settlement unit operable to read the electronic money, and using the read electronic money, perform account settlement for a charge relating to viewing or listening to the content.

7. The playback control apparatus of claim 6, wherein
the account settlement unit measures a playback time of the content, and performs account settlement of the charge in accordance with the playback time.

8. The playback control apparatus of claim 6, wherein
the account settlement unit calculates a data amount of the played content, and performs account settlement of the charge in accordance with the data amount.

9. The playback control apparatus of claim 6, wherein
the content is composed of a digital work and a digital advertisement, and
the account settlement unit calculates a discount amount in accordance with playback of the digital advertisement, and subtracts the discount amount from an amount relating to viewing or listening to the digital work, to calculate the charge.

10. The playback control apparatus of claim 2, further comprising:
a start information acquisition unit operable to acquire start information showing a playback start position in the content,
wherein the playback control unit permits playback of the content by outputting the start information in addition to the key information.

11. The playback control apparatus of claim 10, further comprising:
a start information storage unit operable to store the start information; and
a write unit operable to acquire stop information showing a position in the content at which playback has been stopped, and write the acquired stop information, as the start information, to the start information storage unit,
wherein the acquisition unit acquires the start information from the start information storage unit.

12. The playback control apparatus of claim 2, further comprising:
an electronic money storage unit operable to store electronic money that is used as currency; and
an account settlement unit operable to read the electronic money, and using the read electronic money, perform account settlement for a charge relating to using a service provided within the area.

13. The playback control apparatus of claim 12, wherein
the account settlement unit performs account settlement for, as the charge, a fare for a transport.

14. The playback control apparatus of claim 12, wherein
the account settlement unit performs account settlement for, as the charge, an amount for a ticket for an event held in the area.

15. The playback control apparatus of claim 2, being a portable IC memory card.

16. The playback control apparatus of claim 2, being a mobile terminal.

17. The playback control apparatus of claim 16, further comprising:
a playback unit operable to play the content when the playback control unit permits playback of the content.

18. The playback control apparatus of claim 16, wherein
the mobile terminal obtains the content via the Internet.

19. The playback control apparatus of claim 2, being a playback apparatus and further comprising:
a playback unit operable to play the content when the playback control unit permits playback of the content.

20. The playback control apparatus of claim 2, further comprising:
a notification unit operable to, when the playback control unit prohibits playback, give notification that playback of the content is possible within the area.

21. The playback control apparatus of claim 1, further comprising:
a key storage unit operable to store key information for decrypting encrypted content generated by encrypting the content,
wherein the playback control unit permits playback of the content by outputting the key information when the entry information is acquired, and prohibits playback of the content by refusing to output the key information when the exit information is acquired.

22. The playback control apparatus of claim 1, wherein
the acquisition unit acquires the content as the entry information, and
the playback control unit stores the acquired content, and permits playback of the content by outputting the stored content.

23. The playback control apparatus of claim 22, wherein
the acquisition unit acquires, as the exit information, a deletion instruction instructing deletion of the content, and
the playback control unit prohibits playback of the content by deleting the stored content in accordance with the acquired deletion instruction.

24. A gate apparatus that is located at a gate of an area, and communicates with a playback control apparatus in accordance with entry and exit to and from the area by the playback control apparatus, the playback control apparatus permitting and prohibiting playback of content inside and outside the area, the gate apparatus comprising:
a detection unit operable to detect the playback control apparatus;
a transmission unit operable to, upon the detection unit detecting the playback control apparatus, transmit to the playback control apparatus entry information showing entry into the area through the gate, or exit information showing exit from the area through the gate.

25. The gate apparatus of claim 24, wherein the playback control apparatus, when the exit information is received, prohibits playback of the content, and transmits prohibition completion information showing that playback of the content is prohibited, and the gate apparatus further comprises:
a reception unit operable to receive the prohibition completion information from the playback control apparatus;
a judgment unit operable to judge whether or not the prohibition completion information was received normally; and
a gate control unit operable to close the gate when the judgment unit judges that the prohibition completion information was not received normally.

26. The gate apparatus of claim 24, further comprising:
an acquisition unit operable to acquire start information showing a playback start position in the content,
wherein the transmission unit outputs the start information together with the entry information.

27. A playback control system including a gate apparatus located at a gate to an area, and a playback control apparatus that permits and prohibits playback of the content inside and outside the area,
the gate apparatus comprising:
a detection unit operable to detect the playback control apparatus; and
a transmission unit operable to, upon the detection unit detecting the playback control apparatus, transmit to the playback control apparatus entry information showing entry into the area through the gate, or exit information showing exit from the area through the gate, and
the playback control apparatus comprises:
an acquisition unit operable to acquire the entry information from the gate apparatus when the entry information is transmitted, and acquire the exit information from the gate apparatus when the exit information is transmitted; and
a playback control unit operable to permit playback of at least part of the content according to the entry information when the entry information is acquired, and to prohibit playback of the content according to the exit information when the exit information is acquired.

28. A playback control method used in a playback control apparatus for permitting and prohibiting playback of content inside and outside an area having a gate, the playback control method comprising:
an acquisition step of acquiring, from a gate apparatus located at the gate, either one of entry information showing entry into the area through the gate and exit information showing exit from the area through the gate; and
a playback control step of permitting playback of at least part of the content according to the entry information when the entry information is acquired, and prohibiting playback of the content according to the exit information when the exit information is acquired.

29. An integrated circuit installed in a playback control apparatus for permitting and prohibiting playback of content inside and outside an area having a gate, the integrated circuit comprising:
an acquisition unit operable to acquire, from a gate apparatus located at the gate, either one of entry information showing entry into the area through the gate and exit information showing exit from the area through the gate; and
a playback control unit operable to permit playback of at least part of the content according to the entry information when the entry information is acquired, and to prohibit playback of the content according to the exit information when the exit information is acquired.

30. A playback control program used in a playback control apparatus for permitting and prohibiting playback of content inside and outside an area having a gate, the playback control program comprising:
an acquisition step of acquiring, from a gate apparatus located at the gate, either one of entry information showing entry into the area through the gate and exit information showing exit from the area through the gate; and
a playback control step of permitting playback of at least part of the content according to the entry information when the entry information is acquired, and prohibiting playback of the content according to the exit information when the exit information is acquired.

31. The playback control program of claim 30, stored on a computer readable recording medium.
